(19) United States
(12) Patent Application Publication
(10) Pub. No.: US 2004/0236519 A1
(43) Pub. Date: Nov. 25, 2004

(54) Libraries of confomationally constrained peptides, chiral azacrowns, and peptidomimetics and methods of making the same

(76) Inventors: Garland R. Marshall, Clayton, MO (US); Urzula J. Slomczynska, Ballwin, MO (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/480,070

(22) PCT Filed: Jun. 10, 2002
(86) PCT No.: PCT/US02/18226

Related U.S. Application Data
(60) Provisional application No. 60/297,179, filed on Jun. 8, 2001.

(51) Int. Cl. G06F 19/00

(52) U.S. Cl. 702/21

(57) ABSTRACT

The present invention is directed to the making of library of conformationally constrained peptides and peptidomimetics including chiral azacrowns for use as conformational templates when complexed with metals for the production of conformationally constrained bioactive peptides for use in elucidation of the binding sites and functional groups on the receptor/peptide ternary complex.

### RELATED APPLICATION

Pursuant to 37 C.F.R. § 1.78, this application claims the benefit of United States provisional application serial No. 60/297,179 filed Jun. 8, 2001, which applications is incorporated herein by reference.

### FEDERALLY SPONSORED RESEARCH OR DEVELOPMENT

This invention was developed with Government support from the National Institutes of Health under SBIR DK54157, AI43730, and AI44584. The Government has certain rights to this invention.

### BACKGROUND OF THE INVENTION

The present invention relates to the field of novel conformationally constrained novel peptides, chiral azacrowns, peptidomimetics and their analogs having a specified target property, and libraries containing candidate compounds and their analogs which are retrievable and analyzable for such target property. This invention also relates to methods of using such compounds for pharmaceutical development.

Rational design of pharmaceuticals derived from naturally occurring peptides has been both enhanced and confused by recent technological advances. First, peptide and petidomimetic combinatorial libraries have been instrumental in producing hundreds of thousands of different compounds for biological screening. Houghten et al., Mixture-based synthetic combinatorial libraries, J. Med. Chem., 42:3743-3778 (1999); Houghten et al., Parallel array and mixture-based synthetic combinatorial chemistry: Tools for the next millennium, Annu. Rev. Pharm. Toxicol. 40:3743-3778 (2000). Second, cloning and expressing peptide G-protein coupled receptors (GPCRs) has created mutant and chimeric receptors, thus allowing an opportunity to study peptide-receptor interaction “from the receptor side”. Klasse et al., CD4-Chemokine receptor hybrids in human immunodeficiency virus type 1 infection, J. Virology 73:7453-7466 (1999). The enormous amount of screening data coming from biological testing of libraries on a given receptor needs to be rationalized as it is gathered in order to extract the relevant information to proceed efficiently. The same is true for the data obtained on peptide binding to mutant and chimeric GPCRs; e.g., the observed differences in binding sites/modes for agonists and antagonists. See Schwartz et al., Structure and Function of 7TM Receptors Copenhagen: Munksgaard: 1996.

One of the main obstacles for drug design is the absence of reliable information on the three-dimensional structures of peptide within the ligand-receptor complex, largely due to the difficulty in obtaining structural information on GPCRs. The crystal structure of dark-adapted rhodopsin, the visual pigment, has recently been reported, but rhodopsin is not activated by peptide ligands. Palczewski et al., Crystal Structure of Rhodopsin: A G-Protein-Coupled Receptor, Science 289:739-745 (2000). In the absence of adequate GPCR samples to allow direct characterization of the complex with its peptide ligand, indirect approaches that probe the structure of the complexes are often based on structure-activity studies. Consistently, aromatic residues are found to play a special role in recognition and activation of receptors, with many examples of agonists being converted to antagonist by modification or elimination of a key aromatic side chain. The rigid arrangement of atoms and the resulting large, fixed surface area of aromatic side chains, such as Tyr, Trp, His and Phe, combine to maximize the potential free energy of interaction, as the entropic cost assuming a specific geometry has already been paid by the atoms of the aromatic group. Charged groups, the planar guanidinium, carboxyl, and amino groups, are also often essential recognition sites. Examples of specific recognition of functional groups of peptide receptors include: gastrin tetrapeptide, the side-chain carboxyl of an Asp residue; bradykinin, the guanidinium groups of the Arg residues and the C-terminal carboxyl; and angiotensin, the side-chain phenol, imidazole and phenyl groups as well as the C-terminal carboxyl. Surprisingly, there is little evidence in the literature supporting direct interaction of the amide bonds of the peptide backbone of a hormone in recognizing peptide-hormone receptors.

During recognition, biologically active compounds have shown turns that allow side chains to be re-oriented and exposed, and potentially stabilize a hydrophobic exterior surface. Rose et al., Turns in Peptides and Proteins, Adv. Protein Chem. 37:1-109 (1985); Nikiforovich et al., Three-dimensional recognition requirements for angiotensin agonists: A novel solution for an old problem, Biochem. Biophys. Res. Commun. 195:222-228 (1993); Rizo et al. Constrained Peptides: Models of Bioactive Peptides and Protein Substructures, Annu. Rev. Biochem. 61:387-418 (1992). Tremendous synthetic effort has been expended to develop reverse-turn mimetics, but these scaffolds, often present synthetic difficulties if one also wants to orient the peptide side chains on the turn mimetic. Hanessian et al., Design and Synthesis of Conformationally Constrained Amino Acids as Versatile Scaffolds and Peptide Mimetics, Tetrahedron 53:12789-12854 (1997); Cornille et al., Electrochemical cyclizatoin of dipeptides toward novel bicyclic, reverse-turn peptidomimetics: Synthesis and conformational analysis of 7,5-bicyclic systems, J. Am. Chem. Soc. 117:909-917 (1995); Slomczynska et al, Electrochemical Cyclization of Dipeptides to Form Novel Bicyclic, Reverse-Turn Peptidomimetics .2.Synthesis and Conformational Analysis of 6,5-Bicyclic Systems, J. Org. Chem. 61:1198-1204 (1996).

Some progress in orienting side chains on azabicycloalkane amino acids has been reported by the Lubell group although multistep syntheses are required. Halab et al., Design, synthesis, and conformational analysis of azacycloalkane amino acids as conformationally constrained probes for mimicry of peptide secondary structures [Review], Biopolymers 55:101-102 (2000). In addition, the geometry of the reverse-turn mimetic is often inappropriate to allow the hydrogen bond leading to β-hairpin formation characteristic of many reverse turns. Chalmers et al., Pro-D-NMe-Amino Acid and D-Pro-NMe-Amino Acid: Simple, Efficient Reverse-Turn Constraints, J. Am. Chem. Soc. 117:5927-5937 (1995); Takeuchi et al., Conformational Analysis of Reverse-Turn Constraints by N-Methylation and N-Hydroxylation of Amide Bondsin Peptides and Non-Peptide Mimetics, J. Am. Chem. Soc. 120:5363-5372 (1998). In the case of analogs of somatostatin, many of the amide bonds can be reduced, the direction of the peptide backbone can be reversed, or even the whole peptide backbone can be replaced by a saccharide with side-chain recognition retained at the receptor. Saski et al., Solid-Phase Synthesis and Biological Properties of ψ[CH₂NH]Pseudopeptide Analogues of a Highly Potent Somatostatin Octapeptide, J. Med. Chem. 30:1162-1166 (1987); Hirschmann et al., Medicinal Chemistry in the Golden Age of Biology: Lessons from Steroid and Peptide Research, Angew. Chem Int. Ed. Engl. 30:1278-1301 (1991). Similar, studies on the tripeptide hormone, thyrotropin (TRH, Glp-His-Pro-NH₂), led to a CNS-active analog with the backbone amides replaced by a cyclohexyl scaffold that did not release TSH. Olson et al., Peptide mimetics of tryrotropin-releasing hormone based on a cyclohexane framework: design, synthesis, and cognition-enhancing properties, J. Med. Chem. 38:2866-2879 (1995). Studies determining the bioactive conformation of TRH have led to the design of polycyclic analogs that retain activity at the endocrine receptor responsible for TSH release. Rutledge et al., Conformationally Restricted TRH Analogs—a Probe for the Pyroglutamate Region, J. Med. Chem. 39:1517-1574 (1996); Tong et al., Constrained peptidomimetics for TRH: cis-peptide bond analogs, Tetrahedron 56:9791-9800 (2000).

Unfortunately, GPCRs do not require receptor-bound conformations to place atoms where they can be easily bridged by synthetic connections. Cyclic constraints certainly limit conformational freedom, but more often they preclude the precise biologically relevant conformation either by stabilizing the wrong conformation, or by a steric clash with the receptor due to additional atoms. Connecting two atoms with a bond yields a shorter distance than the sum of the van der Waals radii, thus, restraining the conformation more tightly than possible without the covalent constraint. Fortunately, most receptors have some conformational tolerance and activity is often retained, especially if the synthetic constraint does not hinder the side chains' interaction with the receptor. If the peptide was constrained to exactly the desired conformation, then significant enhanced affinity should result due to changes in the entropy of binding by preorganization. Examples of such dramatic enhancements in affinity by cyclization are extremely rare, however, in the peptide literature.

Non-peptide lead compounds have been isolated using high-throughput screening against peptide receptors; thus, the concept of privileged organic scaffold has emerged. Wiley et al., Peptidomimetics Derived from Natural Products, Med. Res. Rev. 13:327-384 (1993); Evans et al., Methods for drug discovery: development of potent, selective, orally effective cholecystokinin antagonists, J. Med. Chem. 31:2235-2246 (1988); Narlund et al., Peptidomimetic Growth Hormone Secretagogues—Design Considerations and Therapeutic Potential, J. Med. Chem. 41: 3103-3127 (1998). The essence of the privileged organic scaffold concept, as proposed by Evans et al., and reviewed by Patchett and Narglund, is that a chemical scaffold, proven successful in one GPCR system, can be used to generate a library which can then be successfully screened against another GPCRs. Evans et al., Methods for drug discovery: development of potent, selective, orally effective cholecystokinin antagonists, J. Med. Chem. 31:2235-2246 (1988); Patchett et al., Privileged Structures—An Update, Annu. Rep. Med. Chem. 35:289-298 (2000). Combinatorial chemists often use this concept to develop leads that interact with GPCRs. The benzodiazepine scaffold utilized by Evan et al., thought to mimic a reverse turn, continues to generate leads against multiple peptide receptors. Evans et al., Methods for drug discovery: development of potent, selective, orally effective cholecystokinin antagonists, J. Med. Chem. 31:2235-2246 (1988); Blackburn et al., From peptide to non-peptide .3. Atropisomeric GPIIbIIIa antagonists containing the 3,4-dihydro-1H-1,4-benzodiazepine-2,5-dione nucleus, J. Med. Chem. 40:717-729 (1997); Shigeri et al., A potent nonpeptide neuropeptide Y Y1 receptor antagonist, a benzodiazepine derivative, Life Sci. 63:L 151-160 (1998); Dziadulewicz et al., The design of non-peptide human bradykinin B2 receptor antagonists employing the benzodiazepine peptidomimetic scaffold, Bioorg. Med. Chem. Lett. 9:463-468 (1999); Miller et al., Discovery of Orally active nonpeptide vitronectin receptor antagonists based on a 2-benzazepine Gly-Asp mimetic, J. Med. Chem. 43:22-26 (2000).

Kessler advocated cyclic heterochiral penta- and hexapeptides as conformational scaffolds for probing receptor recognition, where a recognition motif (such as RGD) is systematically shifted around cyclic peptide backbone structures to spatially sample various conformations. Pfaff et al., Selective recognition of Cyclic RGD Peptides of NMR Defined Conformation by αIIbβ3, αVβ and α5β1 Integrins, J. Biol. Chem. 269:20233-20238 (1994); Haubner et al., Stereoisomeric Peptide Libraries and Peptidomimetics for Designing Selective Inhibitors of the α_{V}β₃ Integrin for a New Cancer Therapy, Angew. Chem. Int. Ed. Engl. 36:1374-1389 (1997). Porcelli et al. utilized this approach to discover a novel substance P antagonist. Porcelli et al., Cyclic pentapeptides of chiral sequence DLDDL as scaffold for antagonism of G-protein coupled receptors: synthesis, activity and conformational analysis by NMR and molecular dynamics of ITF 1565 a substance P inhibitor, Biopolymers 50:211-219 (1999). Haskell-Luevano et al. screened a library of 951 compounds based upon the β-turn motif and identified the first two non-peptidic heterocyclic micromolar agonists associated with the melanocortin-1 receptor. Haskell-Luevano et al., Compounds that activate the mouse melanocortin-1 receptor identified by screening a small molecule library based upon the beta-turn, J. Med. Chem. 42:4380-4387 (1999). Another example is the rapid identification of selective agonists of the five somatostatin-receptor subtypes through combinatorial chemistry, an important pharmacological tool for understanding their physiological roles in therapeutics. Rohrer et al., Rapid Identification of Subtype-Selective Agonists of Somatostatin Receptor Through Combinatorial Chemistry, Science 282:737-740 (1998). Certainly, the wide variety of organic scaffolds that have resulted from screening against particular GPCRs have provided multiple opportunities for lead optimization.

Combinatorial chemistry has taught us that many different chemical structures can interact with a given GPCR and yield therapeutic candidates with nanomolar affinities upon optimization. Czarnik et al., A practical Guide to Combinatorial Chemistry, Washington, D.C.: American Chemical Society, 1997. Nevertheless, data obtained by structure-activity relationships (SAR) studies of the parent peptide and efforts to determine the receptor-bound conformation are often decisive in library design and lead optimization. Peptide leads can serve as privileged scaffolds. For example, a selective agonist for the somatostatin receptor subtypes II was based on the knowledge derived from work done at Merck on peptide analogs of somatostatin. Yang et al., Synthesis and Biological Activities of Potent Peptidomimetics Selective for Somatostatic Receptor Subtype 2, Proc. Natl. Acad. Sci. USA 95:10836-10841 (1998). Analogs of the potent somatostatin peptide agonists L-363,301 c[-Pro-Phe-d-Trp-Lys-Thr-Phe-] yielded an antagonist of the neurokinin-1 receptor as well as μ- and δ-opioid receptor antagonists. Schiller et al., Novel ligands lacking a positive charge for the delta- and mu-opioid receptors, J. Med. Chem. 43:551-559 (2000).

While sequential interactive approaches on the parent peptide cannot be expected to compete with combinatorial approaches, parallel synthesis and testing of multiple analogs with different conformational constraints (α-methyl and N-methyl amino acids, D-amino acids, betidamino acids , dehydroamino acids, chimeric amino acids, amide and disulfide cyclic constraints, bicyclic reverse-turn mimetics, metal-binding sites, etc.) offers a rapid approach to determination of the receptor-bound conformation. Marshall et al., A Hierarchical Approach to Peptidomimetic Design, Tetrahedron 49:3547-3558 (1993); River et al., Betidamino acids: versatile and constrained scaffolds for drug discovery, Proc. Natl. Acad. Sci. USA 93:2031-2036 (1996); See also Hanessian et al., Design and Synthesis of Conformationally Constrained Amino Acids as Versatile Scaffolds and Peptide Mimetics, Tetrahedron 53:12789-12854 (1997); Comille et al., Electrochemical cyclization of dipeptides toward novel bicyclic reverse-turn peptidomimetics: Synthesis and conformational analysis of 7,5-bicyclic systems, J. Am. Chem. Soc. 117:909-917 (1995); Chalmers et al., Pro-D-NMe-Amino Acid and D-Pro-NMe-Amino Acid: Simple, Efficient Reverse-Turn Constraints, J. Am. Chem. Soc. 117:5927-5937 (1995). The hierarchical approach to peptidomimetic design that has evolved is shown in FIG. 1. See also Marshall G R, A Hierarchical Approach to Peptidomimetic Design, Tetrahedron 49:3547-3558 (1993); Beusen et al., Pharmacophore Definition Using the Active Analog Approach, Pharmacophore Perception, Development, and Use in Drug Design, Edited by Guner O F: International University Line, p.21-45 (2000).

Structure-activity relationships (SARs) usually assume that compounds that have activity at the same receptor and show competitive binding interact with the same site. Considering the allosteric nature of GPCR activation and mutational studies on GPCRs and ligand interaction, this is clearly an untenable assumption. The receptor-bound conformation of the peptide relevant to non-peptide agonists and antagonists may or may not be discovered through screening. Often there is no obvious chemical basis for even assuming interaction at the same site despite literature filled with such efforts including our own. It is therefore necessary to utilize conformationally constrained peptidomimetics, compounds containing non-peptidic structural elements that are capable of mimicking or antagonizing the biological action(s) of a natural parent peptide, to enable determination of binding requirements. Conceptually, one needs to distinguish between true peptidomimetics, where a non-peptide binds to the same site on the receptor as the parent hormone in an analogous binding mode, and those cases where another allosteric site, or alternate binding mode, is involved. Only in the case of true peptidomimetics would one expect the receptor-bound conformation to provide insight into the binding requirements for the true peptidomimetic. In order to derive true peptidomimetics, we propose a stepwise conversion of the peptide retaining those side chains critical for recognition of the peptide. Modification of such side chains in the parent peptide and the peptidomimetic provide an indirect basis to test a common binding mode. Studies of binding against a battery of receptor mutants to show parallel SAR for the peptide and the peptidomimetic is required to support the contention that a true peptidomimetic has been derived.

It would, therefore, be extremely useful to develop a variety of “conformational templates”, i.e. model ligands that should satisfy at least three requirements: (i) they should possess only one three-dimensional structure (or just a few well-determined three-dimensional structures); (ii) they should be readily accessible synthetically, and (iii) they should be able to uniquely orient the peptide-receptor interaction. Because of the vast experience in combinatorial peptide chemistry and the wide variety of protected unusual amino acids available commercially cyclic peptides and their synthetically accessible derivatives, chiral azacrowns are a good source of conformational templates. See Ovchinnikov et al., The Cyclic Peptides: Structure, Conformation, and Function, The Proteins, Edited by Neurath H, Hill R L :Academic Press, Vol. 5 p. 307-642 (1982). Some of these templates may be cyclodipeptides or diketopiperazines (DKPs), cyclotripeptides (C3Ps), cyclotetrapeptides (CTPs) and cyclopentapeptides (CPPs). For optimal use of such conformational templates, virtual screening of the libraries will allow rational selection of synthetic targets in an efficient manner.

Extensive experimental studies of the three-dimensional structures of CPPs have been performed in the last two decades both by X-ray crystallography, mostly by the Karle group, by the Italian groups and by the Gierasch group. Karle I L, Gly-L-Pro-L-Ser-D-Ala-L-Pro in the Crystalline State and an Example of Rotational “Isomerism” between Analogues, J. Am. Chem. Soc. 101:181-184 (1979); Karle I L, Crystal Structure and Conformation of cyclo-(Glycylprolylglycyl-D-alanylprolyl) Containing 4-1 and 3-1 Intramolecular Hydrogen Bonds, J. Am. Chem. Soc. 100:1286-1289 (1978); Karle I L, The peptides, Analysis, Synthesis, Biology, Edited by Gross E, Meienhofer J: Academic Press, Vol. 4, p. 1-54 (1981); Karel I L, Variability in the backbone conformation of cyclic pentapeptides, Int. J. Pept. Prot. Res. 28:420-427 (1986); Toniolo C, Intramolecularly hydrogen-bonded peptide conformations, CRC Crit. Rev. Biochem., 9:1-44 (1980); Lombardi et al., Unusual Conformational Preferences of beta-alanine containing cyclic peptides. VII., Biopolymers 38:683-691 (1996); Zanotti et al., Structure of cyclic peptides: the crystal and solution conformation of cyclo(Phe-Phe-Aib-Leu-Pro), J. Peptide Res. 51:460-466 (1998); Stroup et al., Crystal Structure of cyclo(Gly₁-L-Pro₂-D-Phe₃-L-Ala₄-L-Pro₅): A Cyclic pentapeptide with a Gly-L-Pro δ Turn, J. Am. Chem. Soc. 110:5157-5161 (1988); Stroup et al., Crystal Structure of cyclo(Gly-L-Pro-D-Phe-Gly-L-Val): An Example of a new Type of Three-Residue Turn, J. Am. Chem. Soc. 110:5157-5161 (1988). The X-ray structures are available for several CPPs, including those containing unusual amino acids. Zanotti et al., Structure of cyclic peptides: the crystal and solution conformation of cyclo(Phe-Phe-Aib-Leu-Pro), J. Peptide Res. 51:460-466 (1998); Anwer et al., Backbone modifications in cyclic peptides. Conformational analysis of a cyclic pseudopentapeptide containing a thiomethylene ether amide bond replacement, Int. J. Pept. Prot. Res. 36:392-399 (1990). The Gierasch group, accumulated a large amount of information by NMR concerning CPPs with one or to proline residues, and the Kessler group, which studied mostly CPPs containing D-amino acid residues. Stradley et al., Cyclic Pentapeptides as Models for Reverse Turns: Determination of the Equilibrium Distribution Between Type I and Type II Conformations of Pro-Asn and Pro-Ala β-Turns, Biopolymers 29:263-287 (1990); Koppitz et al., Synthesis of Unnatural Lipophilic N-(9-H-Fluoren-9-ylmethoxy)carbonyl-Substituted α-amino Acids and their Incorporation into Cyclic RGD-Peptides: A Structure Activity Study, Helv. Chim. Acta 80:1280-1300 (1997).

In fact, employment of CPPs as conformational templates for receptor probes with known three-dimensional structures was initiated by the Kessler group in the early nineties. Mastle et al., Cyclo(D-Pro-L-Pro-D-Pro-L-Pro): Structural Properties and cis/trans Isomerization of the Cyclotetrapeptide Backbone, Biopolymers 28:161-174 (1989); Kessler et al., Selective RGD peptides for Inhibition of Cell-Cell interactions via backbone cyclization, Peptides 1992, Proc. Twenty-Second Europ. Peptide Symp. Edited by Schneider et al., ESCOM; p. 75-76 (1993); Muller et al., Pharmacophore refinement of gpIIb/IIIa antagonists based on comparative studies of antiadhesive cyclic and acyclic RGD peptides, J. Comp-Aided Mol. Design, 8:709-730 (1994); Muller et al., Dynamic Forcing, a Method for Evaluating Activity and Selectivity Profiles of RGD (Arg-Gly-Asp) Peptides, Angew. Chem. Inst. Ed. Engl. 31:326-328 (1992). Based on extensive NMR measurements, they proposed a “conformational template” of the (aBCDE) type (the lower case denotes D-amino acids) that possessed a single conformation characterized by a αII′-turn centered at the aB fragment, and a γ-turn at the D residue. Gurrath et al., Conformation/activity studies of rationally designed potent anti-adhesive RGD peptides, Eur. J. Biochem. 210:911-921 (1992). Moving the position of the D-amino acid reside along the sequence, it would be possible to obtain new conformational templates of the same type, and to use the data of their biological testing for elucidation of a peptide pharmacophore. The Kessler group applied the above approach to RGD peptides, and has designed several types of corresponding peptidomimetics. Haubner et al., Stereoisomeric Peptide Libraries and Peptidomimetics for Designing Selective Inhibitors of the α_{V}β₃ Integrin for a New Cancer Therapy, Angew. Chem. Int. Ed. Engl. 36:1374-1389 (1997); Haubner et al., Structural and Functional Aspects of RGD-Containing Cyclic Pentapeptides and Highly Potent and Selective Integrin α_{V}β₃ Antagonists, J. Am. Chem. Soc. 118:7461-7472 (1996); Haubner et al., Cyclic RGD Peptides Containing β-Turn Mimetics, J. Am. Chem. Soc. 118:7881-7891 (1996). Schumann et al. have recently reported on the inclusion of β-amino acids in cyclic peptides resulting in the stabilization of the overall structure with the β-amino acid acting as a γ-turn mimetic. Schumann et al., Are β-Amino Acids γ-Turn Mimetics? Exploring a New Design Principle for Bioactive Cyclopeptides, J. Am. Chem. Soc. 122:12009-12010 (2000).

However, this approach can suffer from a serious drawback; most short peptides, even cyclic ones, exist in solution as a mixture of different interconverting conformers. As a consequence, there are unavoidable difficulties in employing only experimental techniques for determining three-dimensional structures of CPPs. X-ray studies produce knowledge of a very few three-dimensional structures stabilized during the process of crystallization by intermolecular interactions in the crystal lattice; these three-dimensional structures rarely correspond to the “receptor-bound” conformer(s). Marshall G R, Peptide Interactions with G-Coupled Protein Receptors, Curr. Pharmaceutical Design, 2001 (in press). On the other hand, each value of the conformational parameter measured by the NMR spectroscopy (like the vicinal coupling constants, NOE's, etc.) represents an average over an unknown number of conformers with significant statistical weights. An attempt to fit all measured parameters into a single three-dimensional structure imposing the corresponding restrictions can be justified only in the very unlikely case that one conformer exists in solution with a highly predominant statistical weight. Many researches tackle this problem of conformational averaging either by relaxing the NMR-derived limitations imposed on the single conformer, or by generating a random family of conformers that satisfy the NMR limitations as a whole. Muller et al., Dynamic Forcing, a Method for Evaluating Activity and Selectivity Profiles of RGD (Arg-Gly-Asp) Peptides, Angew. Chem. Inst. Ed. Engl. 31:326-328 (1992); Mierke et al., Peptide flexibility and calculations of an ensemble of molecules, J. Am. Chem. Soc. 116:1042-1049 (1994); Cuniasse et al., Accounting for Conformational Variability in NMR Structure of Cyclopeptides: Ensemble Averaging of Interproton Distance and Coupling Constant Restraints, J. Am. Chem. Soc. 119:5239-5248 (1997). In both cases, the suggested three-dimensional structures are refined by some procedures involving energy calculations, such as molecular dynamics simulations. As a result, the molecule is forced into the nearest energetic minimum (minima) which is (are) not necessarily of low relative conformational energy. A vivid example is provided by a recent study by Zanotti et al. showing that the same cyclopentapeptide [cyclo(Phe-Phe-Aib-Leu-Pro)] possessed different conformation in the crystal state and in various apolar solutions; non of which conformations are of the βII′□ type. Zanotti et al., Structure of cyclic peptides: the crystal and solution conformation of cyclo(Phe-Phe-Aib-Leu-Pro), J. Peptide Res. 51:460-466 (1998).

Synthesis and conformational analysis of conformationally constrained amino acids and peptides, and the conformational impact of chemical modification of amino acids and of inclusion of cyclic constraints are important to the production of pharmaceuticals. Recent publications in this area have featured both the chemistry and conformational analysis of reverse-turn peptidomimetics , and cis-amide bond mimetics including 1,5-disubstituted tetrozoles and azaproline. Chalmers, et al., Pro-D-NMe-Amino and D-Pro-NMe-Amino Acid: Simple, Efficient Reverse-Turn Constraints. J. Am. Chem. Soc., 117:5927-5937 (1995); Takeuchi et al., Conformational Analysis of Reverse-Turn Constraints by N-Methylation and N-Hydroxylation of Amide Bonds in Peptides and Non-Peptide Mimetics. J. Am. Chem. Soc., 120:5363-5372 (1998); Zabrocki et al., Conformational Mimicry. 3. Synthesis and Incorporation of 1,5-Disubstituted Tetrazole Dipeptide Analogues Into Peptides with Preservation of Chiral Integrity: Bradykinin, J. Org. Chem., 57:202-209 (1992); Zabrocki et al., Synthesis of a Somatostation Analog Containing a Tetrazole cis-Amide Bond Surrogate, Proc. 11th Am. Peptide Symp., 195-197 (1990); Berglund et al., Conformational analysis of azaproline and other turn inducers, Peptides for the New Millenium (Proc. 16th AM Peptide Soc.), Edited by Fields et al., Kluwer Academic Publishers; 309-310 (1999); Zhang et al., [AzPro³]-TRH. Impact of Azaproline on Cis-Trans Isomerism, Peptides 2000: Proc. 26th European Peptide Symp., Edited by Martines J:EDK; 2001, in press. Chimeric amino acids have been prepared and incorporated in a variety of biologically active peptides to probe their biologically active conformations. Nikiforovich et al., Three-dimensional recognition requirements for angiotensin agonists: A novel solution for an old problem, Biochem. Biophys. Res. Commun., 195:222-228 (1993); Marshall et al., Chimeric Amino Acid as Tools in Conformational Analysis: Brackinin and Angiotensin II, In Peptide Chemistry, Proc. 2nd Japanese Symposium on Peptide Chemistry, Edited by Yanihara N: ESCOM Scientific Publishers; 1993:474-478 (1992); Kaczmarek et al., Chimeric amino acids in cyclic bradykinin analogs: evidence for receptor-bound turn conformation, Peptides: Chemistry, Structure and Biology (13th American Peptide Symposium); Leiden, Edited by Hodges et al., ESCOM Scientific Publishers: 687-689 (1994); Olma et al., Chimeric amino acids in cyclic GnRH anatagonists, Peptides: Chemistry, Structure and Biology (13th American Peptide Symposium); Leiden, Edited by Hodges et al., ESCOM Scientific Publishers: 684-686 (1994); Nikiforovich et al., Topographical Requirements for Delta-Selective Opiod Peptides, Biopolymers, 31:941-955 (1991); Nikiforovich et al., Models for A- and B-receptor-bound conformations of CCK-8, Biochem. Biophys. Res. Commun.194:9-16 (1993).

Recently, the conformation of a peptide, the C-terminal undecapeptide, of the α-subunit of transducin, bound to photoactivated rhodopsin, the prototypical GPCR, was determined by transfer NOE spectroscopy. Kisselev et al., Light-activated rhodopsin induces structural binding motif in G protein alpha subunit, Proc. Natl. Acad. Sci. USA 95:4270-4275 (1998). Despite this successful determination of the first receptor-bond conformation of a peptide complexed with a GPCR, such a direct approach cannot be used on other GPCRs due to the limited quantities available for biophysical study. Syntheses of substituted prolines and pipecolic acids to position side chains have been an interest. Kolodziej et al., Ac-[3- and 4-alkylthioproline31]-CCK4 analogs: synthesis and implications for the CCK-B receptor-bound conformation, J. Med. Chem., 38:137-149 (1995); Kolodziej et al., Stereoselective Syntheses of 3-Mercaptoproline Derivatives Protected for Solid Phase Peptide Synthesis, International Journal of Peptide & Protein Research (1996); Makara et al., A Facile Synthesis of 3-Substituted Pipecolic Acids, Chimeric Amino Acids, Tetrahedron Lett. 38:5069-5072 (1997). This extensive background in the chemistry, conformational analysis and design of peptidomimetics provides a comprehensive foundation for the present invention.

Accordingly, a need exists for conformational templates for model ligands that are constrained in one conformation for the purpose of defining ligand binding sites for receptors.

### SUMMARY OF THE INVENTION

The present invention solves the prior art problems discussed above and provides a distinct advance in the state of the art. In particular, the present invention provides a method of conformationally constraining a flexible molecule for use in determination of the three-dimensional conformation and location of one or more active sites on the flexible molecule for binding with a receptor of interest. The method includes a first step of providing a molecule selected from the group consisting of peptides and peptidomimetics having a metal ion complexing backbone with at least one amide moiety therein. The next step includes substituting at least one hydroxamate or hydroxamate analog moiety for at least one amide moiety in the backbone to provide at least one metal ion binding site on the backbone. Finally, a metal ion is complexed to the molecule at the metal ion binding site thereby the conformation of the molecule.

Another preferred method of the present invention includes a method for establishing a three-dimensional conformation and location of one or more active sites on a flexible molecule for binding with a receptor of interest. First, a molecule selected from the group consisting of peptides and peptidomimetics is provided. The molecule has a metal ion complexing backbone with at least one amide moiety therein. Next, at least one desired section of the backbone is selected to act as a metal ion binding site candidate to form a desired conformation of the molecule. At least one hydroxamate or hydroxamate analog moiety is substituted for at least one amide moiety at the metal ion binding site candidate. A metal ion is then complexed to the molecule at the metal ion binding site candidate thereby constraining the conformation of the molecule. The molecule is tested to determine its binding affinity to the receptor of interest and the three-dimensional structure and location of one or more active sites on the molecule is analyzed to determine the receptor-bound conformation of the molecule.

Another method of conformationally constraining a flexible molecule for use in determination of the three-dimensional conformation and location of one or more active sites on the molecule for binding with a receptor of interest is provided. The method includes the step of providing a molecule selected from the group consisting of peptides and peptidomimetics having the general formula:

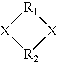

wherein R₁, and R₂ and linked by X and R1 and R2 each comprise from about one to twenty amino acids. X is a metal ion complexing backbone having at least one hydroxamate or hydroxamate analog moiety therein wherein at least one hydroxamate moiety acts as a metal ion binding site. The molecule is then complexed to a metal ion at the metal ion binding site thereby constraining the conformation of the molecule.

The present invention also provides a method of establishing a three-dimensional conformation and location of one or more active sites on a flexible molecule for binding with a receptor of interest. The method includes the steps of providing at least one cyclic peptide molecule, reducing sufficient amide bonds to secondary amines in the cyclic peptide molecule to generate at least one chiral azacrown, and complexing a metal ion to the chiral azacrown thereby constraining the conformation of the chiral azacrown. Next, the chiral azacrown molecule is tested to determine the binding affinity of the chiral azacrown to the receptor of interest and the three-dimensional structure and location of one or more active sites on the chiral azacrown is analyzed to determine the receptor-bound conformation of the chiral azacrown.

Moreover, the present invention provides a method of designing compounds for a desired biological activity including isolating a biologically active molecule of interest, analyzing the conformation of the biologically active molecule, and developing at least one hypothesis for the correct three-dimensional conformation and location of one or more active sites on the molecule for binding to a receptor of interest. Next, at least one active constrained analog of the biologically active molecule is generated which conforms to the hypothesis. The analog is tested to determine the bind affinity of the analog to the receptor of interest and the three-dimensional conformation and location of one or more active sites on the analog in a receptor-bound conformation is mapped. Finally, at least one molecule which mimics the three-dimensional conformation and location of one or more active sites on the analog is designed therefrom.

Furthermore, the present invention provides a library of conformationally constrained molecules selected from the group consisting of peptides and peptidomimetics which are candidates targeted for one or more desired properties. The library of the present invention includes an array of at least five different molecules having different chiralities and combinations thereof wherein any of the candidate molecules are retrievable and analyzable for the desired target properties.

A method of selecting a naturally-occurring molecule having a desired biological activity is also provided by the invention hereof. This method includes obtaining a library of conformationally constrained molecules selected from the group consisting of peptides and peptidomimetics having an array of at least five different molecules having different chiralities and combinations thereof. The library is screened for at least one molecule having a desired binding affinity to a receptor of interest using a biological assay. A three-dimensional structure and location of one or more active sites of the molecule in its receptor-bound conformation is then derived. Next, at least one naturally-occurring molecule having a substantially similar conformation to the molecule discussed above is selected and then tested for the desired biological activity.

The present invention also includes a method of obtaining a pharmacophore which mimics a desired biological-function domain. A library of conformationally constrained molecules selected from the group consisting of peptides and peptidomimetics is first obtained wherein the library includes an array of at least five different molecules having different chiralities and combinations thereof. The library is then screened for at least one molecule having a binding affinity to a receptor of interest and a molecule having the desired biological-function domain is selected. The three-dimensional structure and location of one or more active sites on the molecule is analyzed and a pharmocophore is produced which mimics the three-dimensional structure and location of one or more active sites of the molecule.

Finally, a library of conformationally constrained biologically active molecules is provided for elucidation of a three-dimensional structure and location of one or more binding sites of the molecules. The library includes an array of at least five flexible molecules selected from the group consisting of peptides and peptidomimetics having different chiralities and combinations thereof. Each of the molecules has less than five well-defined three-dimensional structures when bound to a receptor of interest wherein each molecule is synthetically available and at least one side chain of each molecule can be uniquely oriented during interaction with the receptor.

### BRIEF DESCRIPTION OF THE DRAWINGS

These and other features, aspects and advantages of the present invention will become better understood with regard to the following description, appended claims and accompanying figures where:

FIG. 1. A flow chart scheme demonstrating the steps of a hierarchical approach for peptidomimetic design using cyclic pentapeptides and penta-azacrowns;

FIG. 2. A schematic diagram showing the preorganization of a flexible peptide structure by the use of metal coordination to bind into a receptor;

FIG. 3. A chart showing the histograms of statistical weights for low energy of cyclo(DPro1-Ala2-Ala3-Ala4-Ala5), also known as [c(pAAAA)], showing the relative value of energy calculations;

FIG. 4. A diagram showing peptides containing hydroxymates in place of amide bonds to provide metal-binding sites to preorganize peptide conformations. Shown schematically is the expected hexadentate octahedral coordination of a peptide containing three surrogate hydroxymate groups Ψ[CONOH] to a ferric ion;

FIG. 5(A). A chart demonstrating the results of the radioligand binding assays for M40401 for potassium channels (ATP-sensitive, Ca2+Act., VI, potassium channel, Ca2+Act., VS) and sodium channels (site 1 and site 2) as discussed in Example 2. M40401 was tested at a single dose of 10 μM. Results show significant inhibition of the sodium channel site 2 (93.84% inhibition);

FIG. 5(B). A chart demonstrating the results of the radioligand binding assays for M40403 for potassium channels (ATP-sensitive, Ca2+Act., VI, potassium channel, Ca2+Act., VS) and sodium channels (site 1 and site 2) as discussed in Example 2. M40401 was tested at a single dose of 10 μM. Results show significant inhibition of the sodium channel site 2 (84.76% inhibition);

FIG. 6. A chart showing the results of in vitro binding assays for determination of possible opioid activity of M40403 including competition against ligands known to label human opioid mu, delta and kappa receptors in CHO cells as described in Example 3;

FIG. 7. A chart showing the results of in vitro binding assays for determination of possible opioid activity of M40403 including competition against ligands known to label human opioid mu, delta and kappa receptors in CHO cells as described in Example 3;

FIG. 8. A chart showing the results of in vitro binding assays for determination of possible opioid activity of M40403 including competition against ligands known to label human opioid mu, delta and kappa receptors in CHO cells as described in Example 3;

FIG. 9. A chart showing the results of in vitro binding assays for determination of possible opioid activity of M40403 including competition against ligands known to label human opioid mu, delta and kappa receptors in CHO cells as described in Example 3;

FIG. 10. A chart showing the results of in vitro binding assays for determination of possible opioid activity of M40403 including competition against ligands known to label human opioid mu, delta and kappa receptors in CHO cells as described in Example 3;

FIG. 11. A chart showing the results of in vitro binding assays for determination of possible opioid activity of M40403 including competition against ligands known to label human opioid mu, delta and kappa receptors in CHO cells as described in Example 3;

FIG. 12. Overlapping of low-energy conformers of c(RGDFv) and c(RGDfV) in comparison with the X-ray structure of c[β-mercaptobenzoyl)-N-Me-Arg-Gly-Asp-2-mercaptoanilide] as described in Kopple et al., Conformationals of Arg-Gly-Asp Containing Heterodetic Cyclic Peptides: Solution and Crystal Studies. J. Am. Chem. Socl., 114:9615-9623 (1992);

FIG. 13. Cu(II) complexes of the N-terminal segment of peptides and assumed constrained structure. R₁=H, R₂=Trp, R₃=Arg, R₄=Tyr for inhibitor of α-amylase;

FIG. 14. Rhenium complex formation for metal-ion induced distinctive array of structures (MIDAS). For human neutrophil elastase inhibitor, R=Bz, R₁=Ile, R₂=Lys(Adam), R₃=Val-H; for melanocrotin-1 agonist, R=Ac-His, R₁=Phe, R₂=Arg, R₃=Trp-NH₂;

FIG. 15. Orthorgonal views of overlap of side-chain orientations of residues i, i+1 and I+2 α-β vectors of ideal type I β-turn with crystal structure of Mn(II) complex of the unsubstituted penta-azacrown;

FIG. 16. Overlapping of low-energy conformers of c(RGDFv) and c(RGDfV) (right) in comparison with the X-ray structure of c [(β-mercaptobenzoyl)-N-Me-Arg-Gly-Asp-2-mercaptoanilide](left);

FIG. 17. Orthogonal views of overlap of the suggested receptor-bound conformer of the RGD triad deduced from c(RGDFv) and c(RGDfV) (right) with two possible modifications of the metal-complexed MACs (left).

### DETAILED DESCRIPTION OF THE PREFERRED EMBODIMENT

Generally, the nomenclature used hereafter, and the laboratory procedures are those well known and commonly employed in the art. Unless defined otherwise, all technical and scientific terms used herein have the same meaning as commonly understood by one of ordinary skill in the art to which this invention relates. Although any methods and materials similar or equivalent to those described herein can be used in the practice or testing of the present invention, the preferred methods and materials are described. To facilitate understanding of the invention, a number of terms as used herein are defined below:

As used herein, the terms “conformationally constrained” or “conformationally constraining” refers to the stabilizing of a peptide compound, chiral azacrown compound or peptidomimetic such that the compound remains in only one three-dimensional conformation, which preferably is its receptor-bound three-dimensional conformation. As used herein, the terms “active sites” or “functional groups” refers to those portions of a ligand molecule that interact with a receptor for binding to the receptor. As used herein, the term “peptidomimetic” refers to a compound containing non-peptidic structural elements that are capable of mimicking or antagonizing the biological action(s) of a natural parent peptide.

The present invention is directed to the making of a library of peptidomimetics such as chiral azacrown, peptides and their synthetically accessible derivatives for use as conformational templates when complexed with metals for the production of conformationally constrained bioactive molecules for elucidation of the binding sites on the receptor/peptide ternary complex. For optimal use of such conformational templates, virtual screening of the libraries will allow rational selection of synthetic targets in an efficient manner. The conformational templates, which are model ligands, should satisfy at least three criteria: (i) they should possess only one three-dimensional structure (or just a few well-defined three-dimensional structures); (ii) they should be readily accessible synthetically, and (iii) they should be able to uniquely orient the peptide side chains that are believed to transfer most of the information during the peptide-receptor interaction. Some useful cyclic peptides and synthetic derivatives thereof are cyclodipeptides, cyclotripeptides, cyclotetrapeptides, and cyclopentapeptides. Some useful chiral azacrowns for this invention are chiral penta-azacrowns (PACs).

Cyclodipeptides, or diketopiperazines (DKPs), are readily accessible synthetically with very restricted conformations as two cis-amide bonds are required for ring closure. Only a limited set of backbone scaffold modifications are possible (L,L; D,L; and their mirror images) and these have all been examined by crystallography. These compounds provide limited diversity in side-chain orientation with the possibility of utilizing the amide nitrogens as attachment points. Convenient solid-phase approaches to libraries of DKPs have been published. Del Fresno et al., Solid-Phase Synthesis of Diketopeperazine, Useful Scaffolds for Combinatorial Chemistry, Tetrahedron Lett. 39:2639-2642 (1998); Bianco et al., Solid-phase Synthesis and structural characterization of highly substituted hydroxyproline-based 2,5-diketopiperazines, J. Org. Chem. 65:2179-2187 (2000); Lin et al., Utilization of Fukuyama's sulfonamede protecting group for the synthesis of N-substituted alpha-amino acids and derivatives, Tetrahedron Lett. 41:3309-3313(2000); Nefzi et al., Solid-phase synthesis of substituted 2,3-diketopiperazines from reduced polyamides, Tetrahedron 56:3319-3326 (2000). DKPs are generated from peptides enzymatically and often have interesting biological effects on their own. Prasad et al., Bioactive Cyclic Dipeptides, Peptides 16:151-164 (1995).

Cyclotripeptides (C3Ps) possess a 9-membered ring, but are sometimes difficult to cyclize and therefore require some distortion of the geometry of the three cis-amide bonds. Ovchinnikov et al., The Cyclic Peptides: Structure, Conformation, and Function, The Proteins, Edited by Neurath et al., Academic Press, vol. 5, p.307-642 (1982). For this reason, relatively few examples exist in the literature. In general, a C3-symmetric conformation of the backbone slowly interconverts with non-symmetric conformations. Cyclo(D-Pro-L-Pro-D-Pro) exists in a boat conformation, both in solution and in the crystal. Bats et al., Boat Conformation of cyclo-[L-Pro₂-D-Pro], Angew. Chem. Int. Ed. Engl. 18:538-539 (1979).

Limited candidates for conformational templates are cyclotetrapeptides (CTPs) due to their small 12-member ring and equilibration between cis- and trans-amide bond conformers. CTPs have been studied and empirical rules for predicting their conformation proposed. Kato et al., Empirical rules predicting conformation of cyclic tetrapeptides from primary structure, Int. J. Peptide Protein REs. 29:53-61 (1989). Perhaps, of most interest is cyclo(D-Pro-L-Pro-D-Pro-L-Pro) that has only two cycloenantiomeric backbone (cis-trans-cis-trans or trans-cis-trans-cis amide bonds) conformations combined with different puckering of the Cβ and Cγ atoms. Mastle et al., Cyclo(D-Pro-L-Pro-D-Pro-L-Pro): Structural Properties and cis/trans Isomerization of the Cyclotetrapeptide Backbone, Biopolymers 28:161-174 (1989). Derivatives can be prepared readily by solid-phase synthesis as discussed in Mastle et al., or by a convergent solution route with yields of 85% during cyclization. Gilbertson et al., The synthesis and conformation of dihydroxy-cyclo(D-pro-L-pro-D-pro-L-pro), Tetrahedron Lett. 36:1229-1232 (1995). Considering the wide variety of substituted proline derivatives and stereoselective routes to their preparation (3- and 4-mercaptoprolines and 5-alkylprolines, for example), this conformational scaffold deserves consideration. Kolodziej et al., Stereoselective Synthesis of 3-Mercaptoproline Derivatives Protected for Solid Phase Peptide Synthesis, Int. Jour. Pept. & Protein Research, (1996); Ho et al., An Asymmetric Synthesis of cis-5-Alkylproline Derivatives, J. Org. Chem. 51:2405-2408 (1986); Ibrahim et al., Synthesis of Enantiopure Delta-Oxo Alpha-Amino Esters and Prolines Vis Acylation of N-(Phenylfluorenyl) Glutamate Enolates, J. Org. Chem. 58:6438-6441 (1993); Weisshoff et al., Cyclic cholecystokinin-analog pentapeptide cyclo(Asp-Trp-Met-Asp-Phe): An unexpected solution conformation, Biochem. Biophys. Res. Commun. 213:506-512 (1995). In the case of cyclo (D-Pro-L-Pro(4-OH)-D-Pro-L-Pro(4-OH)), only one cycloenantiomer (tctc) was produced upon cyclization of the linear tetrapeptide. Gilbertson et al., The synthesis and conformation of dihydroxy-cyclo(D-pro-L-pro-D-pro-L-pro), Tetrahedron Lett. 36:1229-1232 (1995).

Excellent candidates for the conformational templates of the present invention are cyclopentapeptides (CPPs). CPPs are a preferred conformational template for the present invention. First, they are relatively conformationally rigid. Second, different types of CPPs can reproduce different types of conformational elements of the peptide backbone, various β-turns, γ-turns, and even α-helical-like structures. Weisshoff et al., Cyclic cholecystokinin-analog pentapeptide cyclo(Asp-Trp-Met-Asp-Phe): An unexpected solution conformation, Biochem. Biophys. Res. Commun. 213:506-512 (1995). Third, CPPs can be easily modified to include a large variety of side chains. And, fourth, they are synthetically accessible. A recent review points out that CPPs containing D- or non-chiral amino acids in additional to L-amino acids are readily prepared. Schmidt et al., Cyclotetrapeptids and cyclopentapeptides: occurrence and synthesis, J. Pept. Res. 49:67-73 (1997). All-L-amino acids CPPs can also be prepared by solid-phase synthesis using reagents derived from 7-hydroxy-azabenztriazole with quite reasonable yields. Ehrlich et al., Synthesis of cyclic peptides via efficient new coupling reagents, Peptides Chemistry, Structure and Biology, Proceedings of the 13th American Peptide Symposium, Edited by Hodges et al., ESCOM p. 95-96 (1995); Ehrlich et al., Cyclization of all-L pentapeptides by means of HAPyU, Peptides 1994, Proceedings of the 23rd European Peptide Symposium, Edited by Maia HLS:ESCOM p.167-168 (1995).

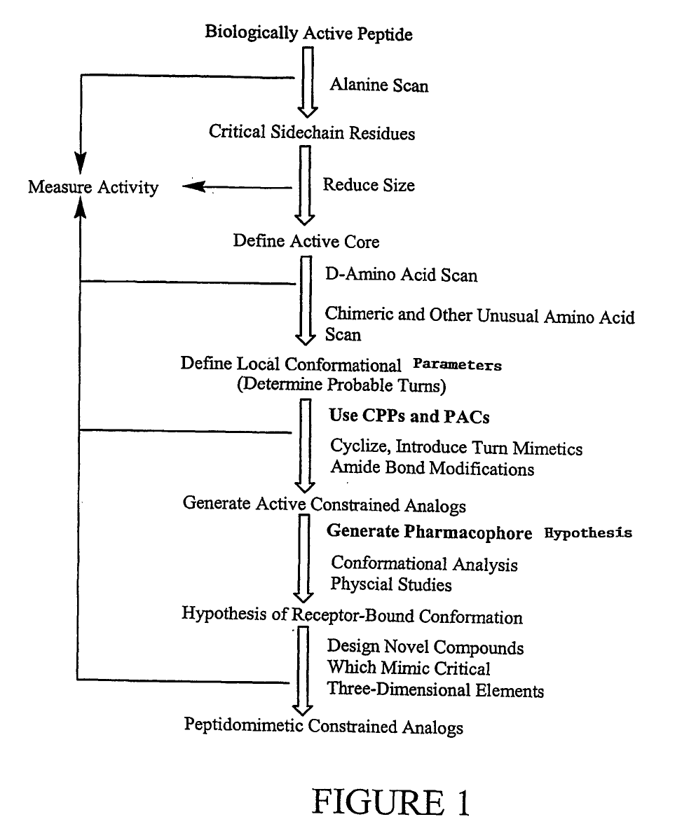

The present invention is directed to the making of a combinatory library of peptides and their synthetic analogs as well as chiral azacrowns, such as pentaazacrowns, for use in the development of pharmaceuticals with the desired biological activity. A hierarchical approach to pharmaceutical and peptidomimetic design is shown in FIG. 1. The present invention adds two steps to this hierarchial approach. These two steps would use the conformational templates developed in this invention to help generate hypotheses for the three-dimensional recognition requirements of the side chains by the receptor, i.e. the pharmacophore. Because of the screening of relevant virtual libraries, other compounds that test these hypotheses may be readily identified and synthesized in the final step. Once the three-dimensional arrangement of side-chain groups is identified, other scaffolds with more desirable drug-like properties may be utilized in the design of ligands through the use of a number of computer-aided design tools. Lauri et al., CAVEAT: A program to facilitate the design of Organic Molecules, J. Comput.-Aided Mol. Des. 8:51-66(1994); Ho et al., FOUNDATION: A program to retrieve subsets of query elements, including active site region accessibility, from three-dimensional databases, J. Comput. Aided Mol. Des. 7:3-22 (1993); Martin et al., MENTHOR, a database system for the storage and retrieval of three-dimensional molecular structures and associate data searchable by substructure, biologic, physical, or geometric properties., J. Comput. Aided Mol. Des. 2:15-29 (1988).

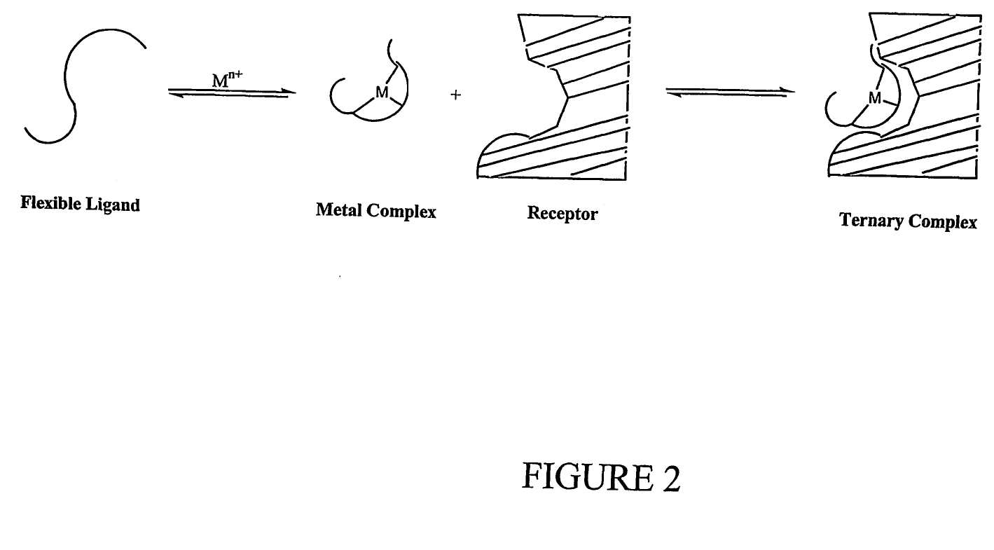

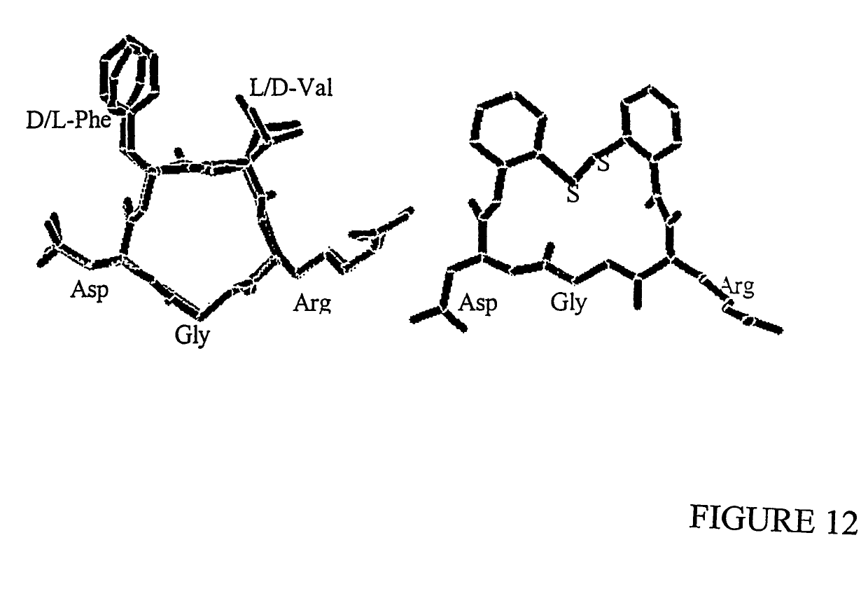

Much effort has been expended to conformationally constrain biologically active peptides in their receptor-bound conformation. These efforts have been driven largely by the desire to enhance the affinity of the peptide ligand for its receptor through preorganization. The impetus for this approach has also derived from the absence of structural details of the primary biological targets, G-protein coupled receptors, for many biologically active peptides. Thus, an indirect method is appropriate to determine the receptor-bound conformation as a prelude to development of a peptidomimetic as a therapeutic. Efforts have extended conventional cyclization by disulfide, amide, or carbon-carbon bonds through the use of metals and the introduction of specific metal-binding sites in the peptide itself. See FIG. 2. U.S. Pat. No. 5,891,418 covering peptides used as “diagnostic imaging, radiotherapeutic, or therapeutic agents with a conformationally constrained global secondary structure obtained by complexing with a metal ion” has recently been issued. The use of a metal template as a strategy for controlling the conformation of a short peptide to mimic the bound conformation was clearly enunciated and demonstrated by Tian and Bartlett. Tian et al., Metal Coordination As a Method for Templating Peptide Conformation, J. Am. Chem. Soc. 118:943-949 (1996). Peptide complexes of Cu(II) were used to mimic the Trp-Arg-Tyr β-turn segment of tendamistat, a proteinaceous inhibitor of α-amylase. These mimetics were based on the structure of the complex of Cu(II) with pentaglycine where the N-terminal amino group and the next three amide nitrogens show square planar coordination to the metal as shown in FIG. 13. Three tetrapeptides containing Trp, Arg, and Tyr residues showed approximately 100-fold increases in inhibition in the presence of Cu(II). One complicating factor in this study was the dissociation of copper from the complex with its inherent amylase inhibitory activity. It is most desirable that the metal complex has stability in the relevant biological milieu to reduce ambiguity in its mechanism of action and to reduce possible toxicity.

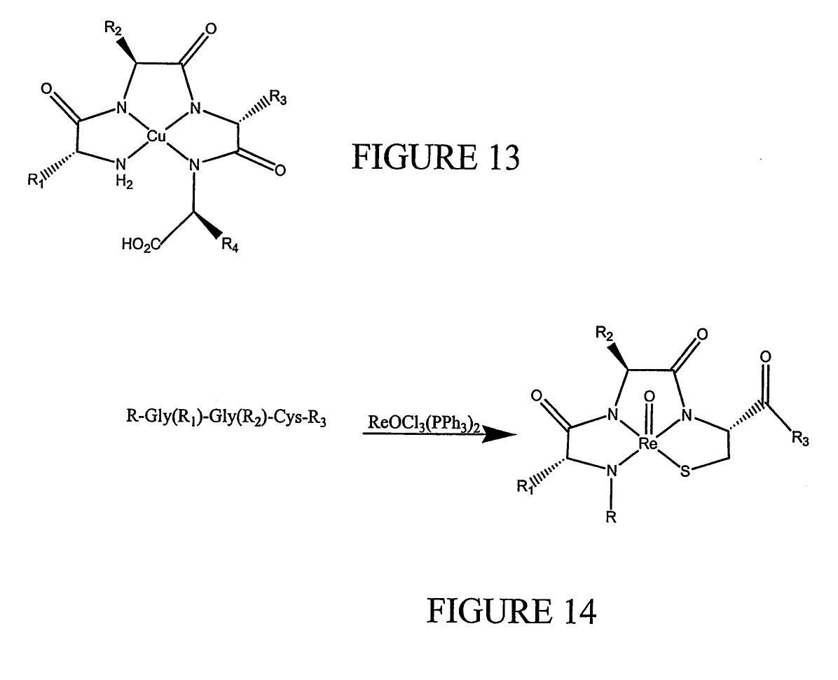

Shi and Sharma have developed a combination approach entitled metal-ion induced distinctive array of structures (MIDAS) in which the amide nitrogens of the N-terminal two amino acids of a peptide preceding a cysteine residue react with rhenium reagent leading to formation of a stable rhenium complex by either solid phase or solution chemistry. Shi et al., Metallopeptide Approach to the Design of Biologically Active Ligands: Design of Specific Human Neutrophil Elastase Inhibitors, Bioorg. Med. Chem. Lett. 9:1469-1474 (1999). This leads to a stabile complex with similar geometry to-the Cu(II) complexes of Tien and Bartlett. Tian et al., Metal Coordination As a Method for Templating Peptide Conformation, J. Am. Chem. Soc. 118:943-949 (1996). A selective inhibitor of human neutrophil elastase and a highly selective agonist of the melanocortin-1 receptor were discovered with the MIDAS approach, as shown in FIG. 14. Shi et al., Metallopeptide Approach to the Design of Biologically Active Ligands: Design of Specific Human Neutrophil Elastase Inhibitors, Bioorg. Med. Chem. Lett. 9:1469-1474 (1999); Shi et al., Conformationally Constrained Metallopeptide Template for Melanocortin-1 Receptor, Abstr. 218th ACS Natl. Meeting; New Orleans, La.: American Chemical Society: MEDI-257 (1999).

In a similar approach, Giblin et al. cyclized α-melanotropin analogs through rhenium and technetium metal coordination, where reduced [Cys^{4,10}, D-Phe7]-α-Msh₄₋₁₃ was complexed with Re(V). Giblin et al., Synthesis and characterization of rhenium-complexed alpha-melanotropin analogs, Bioconjugate Chem. 8:347-353 (1997); Giblin et al., Design and characterization of alpha-melanotropin peptide analogs cyclized through rhenium and technetium metal coordination, Proc. Natl. Acad. Sci. USA 95:12814-12818 (1998). NMR suggested that the tiolate-sulfur of Cys-10 and the two preceding amide nitrogens, as well as the thiolate sulfur of Cys-4, provided a square plane of donor atoms similar to the complex shown in FIG. 14. The binding affinity was reduced approximately 100-fold compared with the disulfide parent. When [Cys^{3,4,10}, D-Phe7]-α-Msh₄₋₁₃ was used instead, the donor atoms were the three thiolate sulfurs and the amide nitrogen between Cys-3 and Cys-4. In this case, the binding affinity improved 25-fold over the previous rhenium complex, but remained 4-fold less than the parent.

Several other groups have also used the amino acid side chains (cysteine, histidine, lysine, aspartic acid, etc.) to participate in specific metal ligation and stabilize a desired conformation. A few examples serve to illustrate this approach. Ghadiri et al. introduced Cys and His at residues i and i+4 of short helical peptide sequences and showed increased helicity in the presence of certain metals. Ghadiri et al., Secondary Structure Nucleation in Peptides. Transition Metal Ion Stabilized α-Helices, J. Am. Chem. Soc. 112:1630-1632 (1990); Ghadiri et al., Peptide Architecture. Design of Stable α-Helical Metallopeptides via a Novel Exchange-Inert Ru^{III} Complex, J. Am. Chem. Soc. 112:9403-9404 (1990). Ruan et al. introduced unusual amino acids containing amino diacetic acid at the i and i+3 or i+4 positions to stabilize helices in the presence of metals. Ruan et al., Metal Ion Enhanced Helicity in Synthetic Peptides Containing Unnatural, Metal-Ligating Residues, J. Am. Chem. Soc. 112:9403-9404 (1990). Cheng et al. prepared several amino acids incorporating powerful bidentate ligands in their side chains. Cheng et al., Metallopeptide Design—Tuning the Metal Cation Affinities with Unnatural Amino Acids and Peptide Secondary Structure, J. Am. Chem. Soc. 118:11349-11356 (1996). Schneider and Kelly utilized novel 6,6′-bis(acylamino)-2,2′-bipyridine-based amino acids designed to replace the i+1 and i+2 residues of a β-turn when complexed with Cu(II). Schneider et al., Synthesis and Efficacy of Square Planar Copper Complexes Designed to Nucleate β-Sheet Structure, J. Am. Chem. Soc. 117:2533-2546 (1995).

Marshall et al. have developed a combinatorial solid-phase approach to produce analogs of a variety of naturally occurring hydroxymate-containing siderophores (desferrioxamine, exochelins, mycobactins, and aerobactin) as potential orally active iron chelators and possible antibiotics. Slomczynska et al., Hydroxamate analog libraries and evaluation of iron affinities, Transfusion Science 23:265-266 (2000); Marshall et al., Combinatorial Chemistry of Metal Binding Ligands, Adv. Suprmolecular Chem. (2001) in press. These methods are disclosed in U.S. patent application Ser. No. 09/360,417 as well as in the international publication number WO 00/04868, both incorporated herein by reference. The chemistry developed for these libraries, including a set of protected nosylhydroxylamine derivatives as well as procedures optimizing library production, are useful for this invention. Exemplary chemical structures of these libraries are shown below:

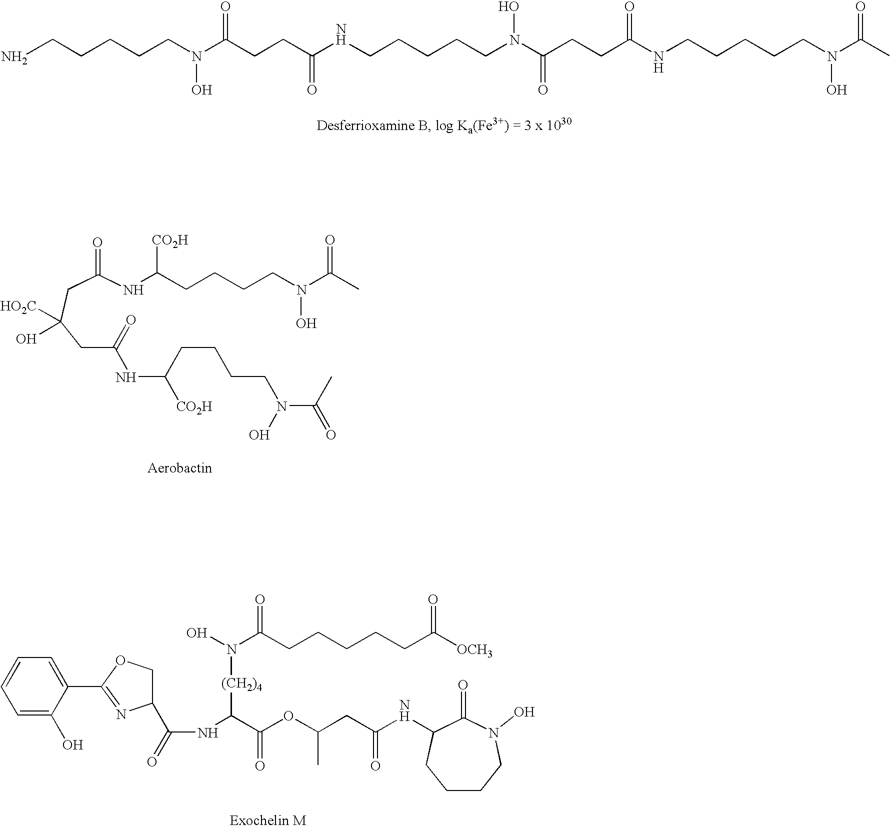

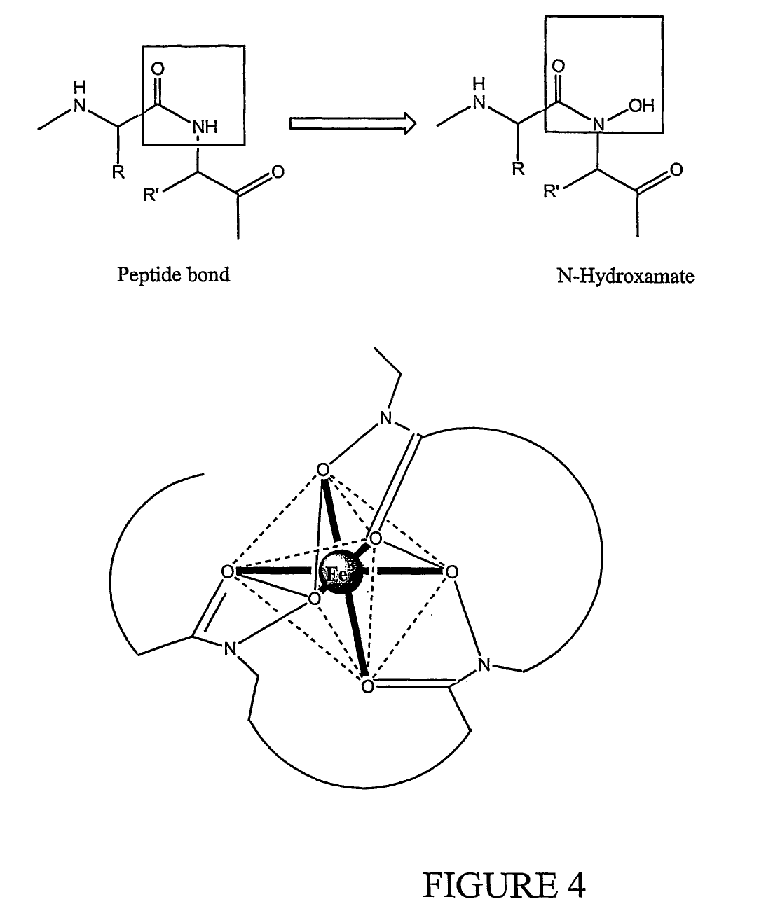

Ye and Marshall have developed synthetic routes to modify the amide backbone to a hydroxymate group to provide multiple metal-binding sites. These molecules mimic the naturally occurring hydroxymate-containing siderophores such as desferrioxamine that are involved in microbial iron transport. Neilands J B, Siderophores: structure and function of microbial iron transport compounds, J. Biol. Chem. 270:26723-26726 (1995). Binding of metals such as Fe(III) by a peptide containing three hydroxymates in a 1:1 complex generally may fix the conformation of the peptide and constrain the relative orientation of side chains. The stability of such a complex will obviously depend on the placement of the three-hydroxyl groups along the peptide backbone. FIG. 4 shows the expected hexadentate octahedral coordination of a peptide containing three surrogate hydroxymate groups in place of amide bonds ψ[CONOH] to a ferric ion.

For synthetic convenience, protected N-hydroxy-L-α-amino acids precursors were prepared for incorporation into peptides in contrast to the in situ incorporation of protected hydroxylamines in the siderophore work. See U.S. patent application Ser. No. 09/360,417 as well as in the international publication number WO 00/04868. To illustrate the approach, a synopsis of the synthesis of three O-protected N-hydroxy-L-α-amino acids is given, i.e. N-benzyloxyglycine t-butyl ester (1) was readily prepared from bromacetic acid t-butyl ester and O-benzylhydroxylamine. N-hydroxy-L-α-amino acid derivatives of high optical purity were efficiently synthesized from their corresponding D-α-hydroxy acid ester analogs via their triflate derivatives and S_{N}2 mechanism, we used commercially available D-(−)-lactic acid t-butyl ester to prepare N-benzyloxyalanine t-butyl ester (2) with an overall yield of 75%. Feenstra et al., An Efficient Synthesis of N-Hydroxy-α-Amino Acid Derivatives of High Optical Purity, Tetrahedron Lett. 28:1215-1218(1987). The synthesis of N-benzyloxyphenylalanine (3) was similarly carried out starting from commercially available D-3-phenyllactic acid that was first converted to the corresponding allyl ester by allyl bromide in the presence of aliquant 336 and NaHCO₃. The resulting N-benzyloxyphenylalanine allyl ester was deblacked with piperidine/Pd(PPh₃)₄ to afford (3) with an overall yield of 65%. Friedrich-Bochtnitschek et al., J. Org. Chem. 54:751 (1989). It is difficult to incorporate N-benzyloxyamino acid building blocks into a peptide using standard peptide coupling methods because of the relatively low nucleophilicity of its NHOBn group. Perlow, D. S., et al. successfully used Fmoc-L-isoleucine acid chloride in the acylation of a sterically hindered N_{δ}-Cbz-piperazic acid N-terminus and the acylation efficiency was further improved by the combination of the acid chloride and AgCN in toluene. Perlow et al., J. Org. Chem. 57:4390-4400 (1992). The reaction of 1 with Fmoc-Val-Cl in the presence of AgCN in toluene afforded Fmoc-Val-[CO(NOH)]-Gly-B^{t} with a yield of 85%. Cleavage of the Bu^{t} group with TFA provided the corresponding acid that was then coupled to alanine t-butyl ester with HBTU to give the tripeptide. The combination of Fmoc-amino acid chloride/AgCN/toluene was used in the synthesis of 5 model compounds: H-Leu-Ψ[CO(NOH)]-Phe-Ala-NHOH, H-Val-Ψ[CO(NOH)]-Xxx-Ala-Leu-NHOH (Xxxx=Gly, Ala or Phe), and H-Val-Ψ[CO(NOH)]-Phe-Ala-Pro-Leu-NHOH. Model reactions revealed that the coupling of the COOH group of N-benzyloxyphenylalanine (3) to the NH₂ group of another amino acid derivatives proceeded smoothly using conventional peptide coupling methods without further protecting the NHOBn group. This can be ascribed to the relatively low basicity and nucleophilicity of the NHOBn group.

Solid-phase methods for the synthesis of peptide hydroxymates, one example of which is shown in Scheme 1, assist in constructing versatile combinatorial metal-binding peptide libraries. There are several reports in the literature on the solid phase synthesis of C-terminal peptide hydroxamic acids useful in the search for metalloprotease inhibitors. Chen et al., Solid Phase Synthesis of Peptide Hydroxamic Acids, Tetrahedron Letters 38:1511-1514 (1997); Dankwardt et al., Solid Phase Synthesis of Hydroxamic Acids, Synlett, 761 (1998); Bauer et al., A Novel Linkage for the Solid-Phase Synthesis of Hydroxamic Acids, Tetrahedron Letters, 38:7233-7236 (1997); Floyd et al., A Method for the Synthesis of Hydroxamic Acids on Solid Phase, Tetrahedron Letters, 37:8045-8048 (1996); Golebiowski et al., Solid Supported Synthesis of Hydroxamic Acids, Tetrahedron Letters 39:3397-3400 (1998); Grigg et al, Solution and Solid-Phase synthesis of Hydroxamic Acids Via Palladium Catalyzed Cascade Reactions, Tetrahedron Letters, 40:7709-7711 (1999). See also, U.S. Pat. No. 5,932,695 and U.S. Pat. No. 5,849,951 for other methods of synthesizing hydroxamic acids and analogs. The dipeptide 5 was used as a building block to synthesize 9 starting from N-Fmoc-hydroxylamino 2-chlorotrityl resin in an overall yield of 60%. This solid-phase product had identical spectroscopic properties with that prepared in solution.

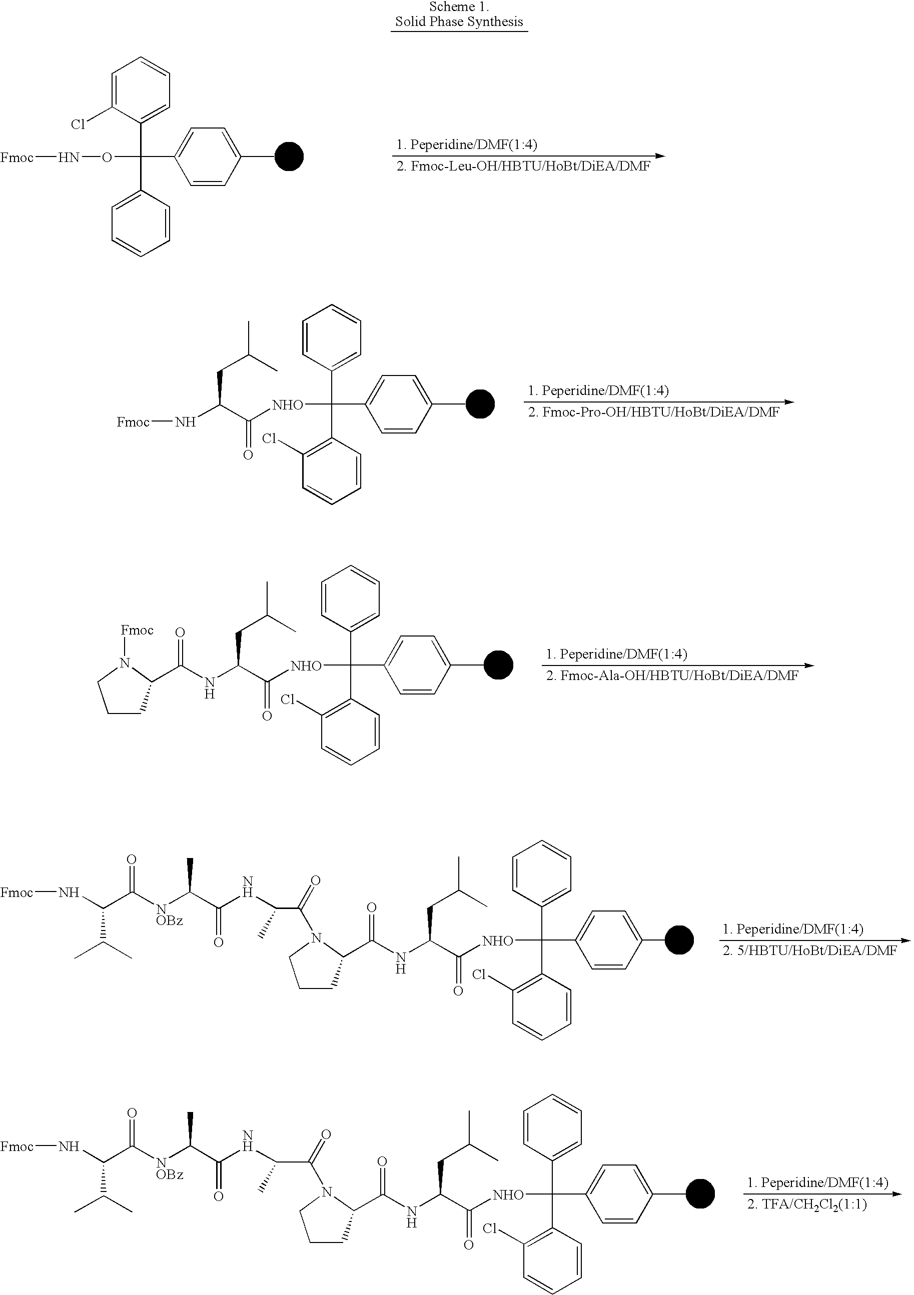

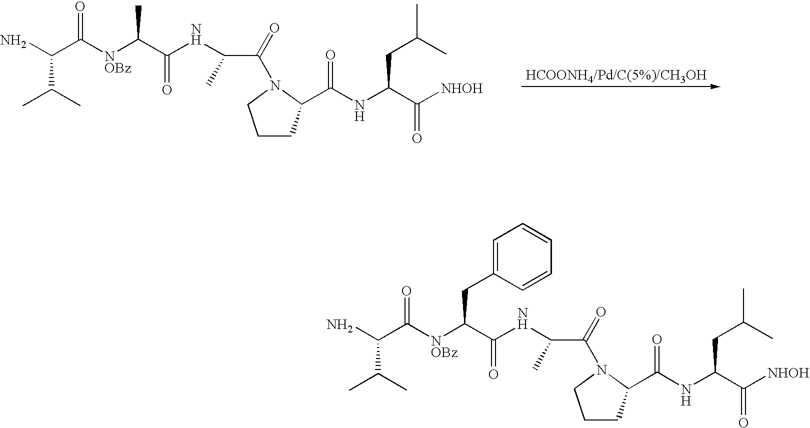

A prototype library with three hydroxamic groups for iron (III) coordination (10 compounds) and two hydroxamic groups for copper coordination (9 compounds) may be prepared to explore their metal affinities. However, these schemes are illustrative, and the invention is not limited to the use of these compounds:

| | |
|---|---|
| 2. | H-Leu-Ψ(CONOH)-Phe-Ala-Leu-Ψ(CONOH)-Phe-Ala- |
| | Leu-Ψ(CONOH)-Phe-Ala-OH |
| 3. | c(-Leu-Ψ(CONOH)-Phe-Ala-Leu-Ψ(CONOH)-Phe-Ala- |
| | Leu-Ψ(CONOH)-Phe-Ala-) |
| 8. | H-Pro-Ψ(CONOH)-Phen-Ala-Pro-Ψ(CONOH)-Phe-Ala- |
| | Pro-Ψ(CONOH)-Phen-Ala-OH |
| 9. | c(-Pro-Ψ(CONOH)-Phe-Ala-Pro-Ψ(CONOH)-Phe-Ala- |
| | Pro-Ψ(CONOH)-Phe-Ala-) |
| 10. | H-Leu-Ψ(CONOH)-Phe-Ala-Pro-Leu-Ψ(CONOH)-Phe- |
| | Ala-Pro-Leu-CONOH |
| 14. | H-Val-Ψ(CONOH)-Phe-Ala-Pro-Leu-CONOH |
| 15. | H-Leu-Ψ(CONOH)-Phe-Ala-Leu-Ψ(CONOH)-Phe-Ala-OH |
| 16. | c(-Leu-Ψ(CONOH)-Phe-Ala-Leu-Ψ(CONOH)-Phe-Ala-) |

The ability of these peptides to bind metals was determined by electrospray-ionization mass spectrometry (hereinafter “ESI-MS”). ESI-MS has been successfully used to study a wide variety of non-covalent interactions owing to the gentle nature of the electrospray-ionization process that allows non-covalent complexes to be introduced intact into the gas phase. Thus, ESI-MS provides equilibrium information about the solution and the relative abundance of different peptide-metal binding complexes. The peptide ligands were dissolved in 50% CH₃CN or methanol and then diluted to 10 mM solution with 1 mM of CH₃COONH₄/10% CH₃OH solution. Stock solutions (200 uM) of the metal ions (CuSO₄, NiSO₄, ZnSO₄, HgSO₄. Co(NO₃)₂) were made. 40 ul of the ligand solution was mixed with 40 ul of the metal-ion solution, diluted with methanol or 1 mM of CH₃COONH₄. The solution was treated with KOH to form the complex. Competitive binding was used to study the relative metal-binding properties of each ligand by adding two different metal ions. By competitive binding analysis, it was determined that compound 14 showed the strongest metal-binding ability of the peptides containing two hydroxymate groups with the following specificity: Cu(II)>Co(II)>Fe(III)>Cd(II)>Zn(II)>Ni(II).

One difficulty with linear constructs is the increased number of isomers that can arise by chelating to the metals with different ordering of the hydroxymate groups around the metal. In the case of desferrioxamine with three hydroxymates, five isomers (so-called “wrapping” isomers) can be formed, as shown in FIG. 4, when binding to a trivalent metal such as Fe(III), each as a racemic (Λ or Δ) mixture. Leong et al., Coordination isomers of biological iron transport compounds. III.(1) Transport of lambda-cis-chromic desferriferrichrome by Ustilago sphaerogena, Biochemical & Biophysical Research Communications, 60:1066-1071 (1974). While one may be energetically more probable than the other nine when other chiral centers are included in the molecule, one must consider that several isomers may co-exist in solution and a mixture of compounds may result to complicate interpretation of biological activity. Yakirevitch et al., Chiral Siderophore Analogs: Ferrioxamines and Their Iron (III) Coordination Properties, Inorganic Chemistry 32:1779-1787 (1993). Cyclization eliminates any isomers in which the N-terminal and C-terminal groups of the linear constructs are not adjacent. This ambiguity in the structure of the complex limits the application of the peptide hydroxymates as conformational templates; there forte, however, is their mimicry of large receptor-bound structures, such as beta hairpins, since there several amino acids are required as a spacer to allow proper geometrical interaction of hydroxymates.

Other compounds useful for this invention are metal complexes of chiral penta-azacrowns (hereinafter “PACs”). Reduction of the amide bonds to secondary amines of a cyclic pentapeptide precursor leads to a flexible chiral cyclic azacrown. The flexibility can be limited by complexation with a metal to fix the side-chair orientations to a manageable set. Riley and co-workers reduced the amide bonds in cyclic pentapeptides by LiAlH₄ or borane to generate penta-azacrown ethers, as shown in Scheme 2, that mimic the enzyme superoxide dismutase (SOD) when complexed with manganese. Aston et al., Asymmetric Synthesis of Highly Functionalized Polyazamacrocycles Via Reduction of Cyclic Peptide Precursors, Tetrahedron Lett. 35:3687-3690 (1994); Neumann et al., Synthesis of Conformationally Tailored Pentaazacyclopentadecanes. Preorganizing Peptide Cyclizations, Tetrahedron Lett. 38:779-782 (1997); Riley et al., Manganese Marcrocyclic Ligand Complexes as Mimics of Superoxide Dismutase, J. Am. Chem. 116:387-388 (1994). U.S. Pat. Nos. 5,874,421 and 5,637,578 and 5,696,109 describe the use of manganese (II), manganese (III), iron (II) or iron (III) complexes of fifteen-membered cyclic compounds, all of which are incorporated herein by reference. Additionally, U.S. Pat. Nos. 6,214,817, 5,610,293, and 6,180,620 describe the synthesis of and use of these cyclic compounds, all of which are incorporated herein by reference. Preorganization of the linear peptide by inclusion of diaminocyclohexane derivatives led to high cyclization yields and enhanced stability of the metal complexes ultimately formed. Neumann et al., Synthesis of Conformationally Tailored Pentaazacyclopentadecanes. Preorganizing Peptide Cyclizations, Tetrahedron Lett. 38:779-782 (1997).

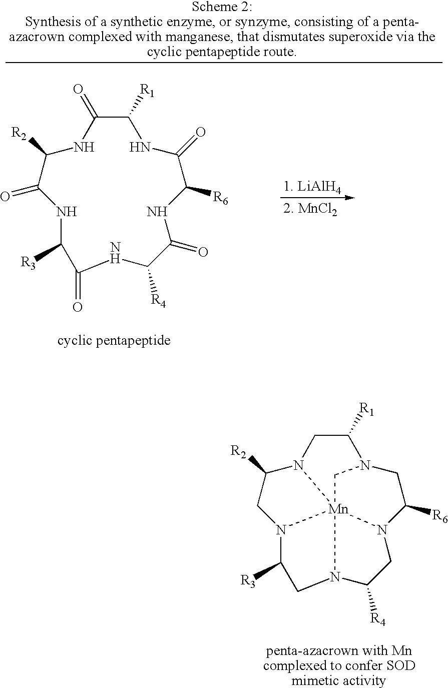

Further optimization of the stability and catalytic efficiency of these SOD mimetics has led to compounds such as M40403 and M40401 (see structures below) with diffusion-controlled catalytic activities and in vivo metabolic stability. Clinical candidates for a variety of inflammatory conditions as well as ischemia/reperfusion injury and refractory hypotension

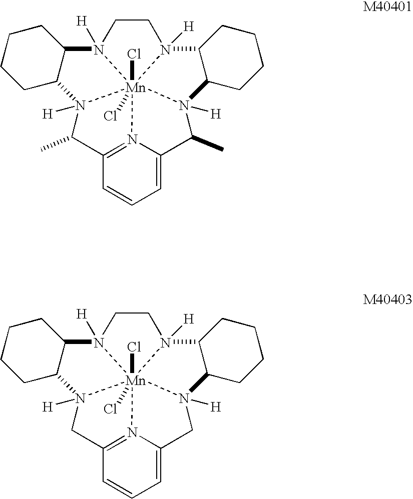

are emerging from the class of SOD mimetic. U.S. Pat. Nos. 6,214,817, 5,610,293, and 6,180,620; Salvemini et al., A nonpeptidyl mimicof Superoxie with Therapeutic Activity in Rats, Science 286:304-306 (1999); Macartur et al., Inactivation of catecholamines by superoxide gives new insight on the pathogenesis of septic shock, Proc. Natl. Acad. Sci. USA 97:9753-9758 (2000). See also, U.S. Pat. Nos. 6,214,817, 5,610,293, and 6,180,620. The elegant chemistry and catalytic insight that has guided the development of this approach has been reviewed by Riley. Riley D P, Functional Mimics of Superoxide Dismutase Enzymes as Therapeutic Agents, Chem. Rev. 99:2573-2587 (1999); Riley et al., Computer-Aide Design (CAD) of Synzymes: Use of Molecular Mechanics (MM) for the Rational Design of Superoxide Dismutase Mimics, Inor. Chem. 38:1908-1917 (1999); Riley D P, Rational Design of Syunthetic Enzymes and Their Potential Utility as Human Pharmaceuticals: Development of Mangenese(II)-Based Superoxed Dismutase Mimics, Adv. Supramolecular Chem. 6:217-244 (2000).

Once the cyclic peptide or its analog or the chiral azacrown is produced that mimics the biologically active peptide of interest and contains metal binding groups, it is constrained into a three-dimensional conformation for binding to a receptor by complexing it to a metal ion. Some metal ions that may be useful for this invention include, but are not limited to, the ionic form of iron, copper, manganese, nickel, zinc, arsenic, selenium, technetium, gadolinium, cobalt, ruthenium, palladium, silver, cadmium, indium, antimony, rhenium, osmium, iridium, platinum, gold, mercury, thallium, lead, bismuth, polonium, astatine, actinides or lanthanides. The actinides include thorium, protactinium, uranium, neptunium, plutonium, americium, curium, berkelium, californium, einsteinium, fermium, mendelevium, nobelium, lawrencium. The lanthanides include cerium, praseodymium, neodymium, promethium, samarium, europium, gadolinium, terbium, dysprosium, holmium, erbium, thulium, ytterbium, and lutetium.

The present invention involves the preparation of combinatorial libraries of relatively rigid peptides, cyclic peptides and their synthetic analogs possessing significantly different conformational possibilities for their peptide backbones. Verification of the three-dimensional structure of the conformational templates formed from the libraries may be done with nuclear magnetic resonance (NMR) and X-ray studies.

A variety of cyclic pentapeptides useful for the present invention may be prepared both in solution and using polymeric supports with on-resin cyclization. There are also a wide variety of alternative methods of preparation of cyclic pentapeptides useful for this invention depending upon the selection of amino acids and possible linkage to the support via the side chain. Shao et al., A Novel Method to Synthesis of Cyclic Peptides, Tetrahedron Lett. 39:3911-3914 (1998). A more general approach is direct attachment of the growing peptide chain through a backbone amide. Jenson et al., Backbone Amide Linker (BAL) Strategy for Solid-Phase Synthesis of C-Terminal-Modified and Cyclic Peptide, J. Am. Chem. Soc. 120:5441-5452 (1998). This approach offers the potential advantage of a secondary amide at the site of attachment of the linker with an increased propensity of a cis-amide bond preorganizing the final peptide for on-resin cyclization. Libraries of CPPs and corresponding PACs can readily be prepared by on-resin cyclization with amino-acid side-chain and an ester linkage to the polymeric support. An example, as shown in Scheme 3, is the use of the Asp side chain and an ester linkage to the polymer cleavable by acid to give the CPP with a free Asp carboxyl, or by reduction with either borane or LiAlH₄ to give the PAC with a serine hydroxyl. The PAC with the free carboxyl could be obtained by acid cleavage, followed by reduction. One variation of normal CPP synthesis that we plan is CPPtoid synthesis. The first major diversion from peptide diversity in combinatorial chemistry was the movement of the side chain from the α-carbon of the amino acid to the amide nitrogen to generate peptoids. Zuckermann et al., Efficient Method for the Preparation of Peptoids [Oligo(N-substituted glycines)] by Submonomer Solid-Phase Synthesis, J. Am. Chem. Soc. 114:10646-10647 (1992). This can easily be accomplished by alkylation of the appropriate alkylamine with bromoacetic acid. Simon et al., Proc. Natl. Acad. Sci. USA 89:9367-9371 (1992). The next step includes adding peptoid units (N-alkyl-Gly)with N-alkylation of the nitrogen of normal amino acids during solid-phase synthesis via the nosyl amino acid as published by Miller and Scanlon. Miller et al., Site-Selective N-Methylation of Peptide on Solid Supports, J. Am. Chem. Soc. 119 (1997). Thus, the amide hydrogen of the CPP becomes another site for side-chain positioning. Scheme 3 below shows the simultaneous preparation of combinatorial libraries of chiral azacrowns for metal complexation and cyclic pentapeptides with product determined by cleavage procedure.

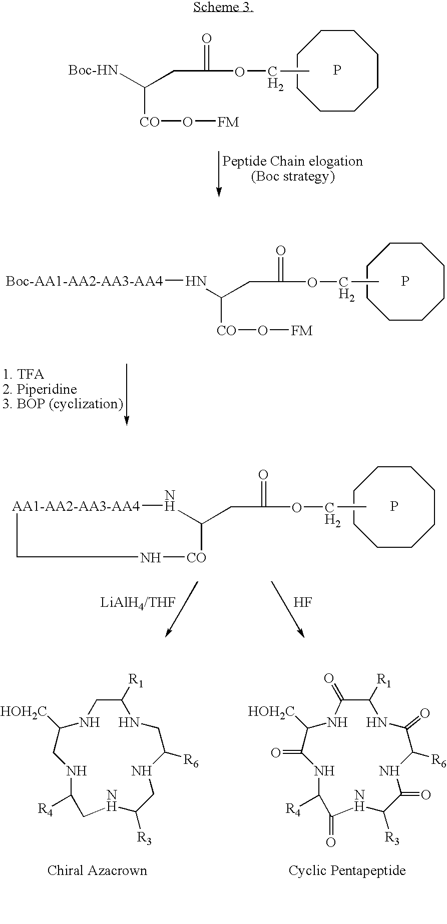

In order to constrain the PAC metal complex to a single conformer and enhance its stability for bioassay, a bicyclic compound such as the DACH and pyridine units seen in M40403 is incorporated. Scheme 4 shows a synthetic approach to the preparation of a library of such compounds.

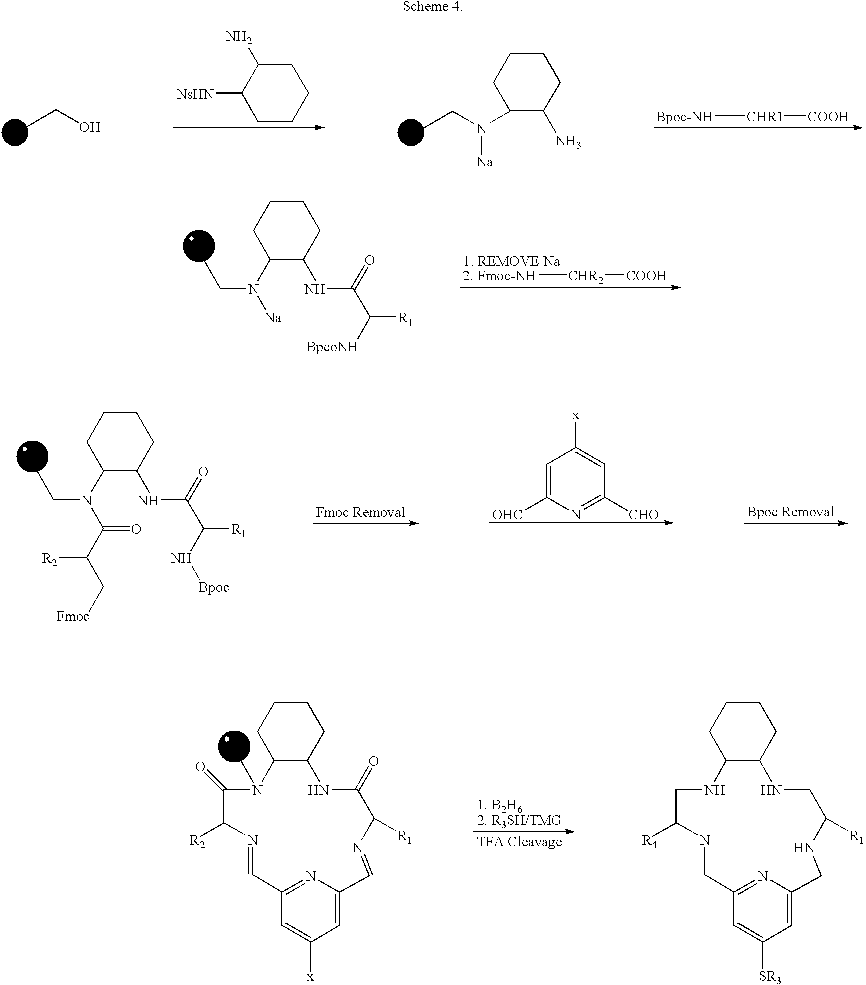

The present invention also involves the preparation combinatorial libraries of metal complexes of chiral azacrowns derived from cyclic peptides. A potential drawback of cyclic peptides is the conflict between a number of pharmacophoric groups for optimal interaction with the receptor and the impact on side-chain position on the template on template conformation. In the case of cyclic pentaglycine (C₁₀N₅O₅H₁₅), there are 5 positions for side chains, either R or S, plus 5 amide nitrogens for substitution for a total of 15 potential side-chain positions (number of hydrogens). For a given cyclic peptide of a given chirality and amide substitution pattern, the conformational template is either fixed to a limited set of conformations, or too flexible to predict the relative orientation of the side chains. By using the azacrown template, 20 potential side-chain positions on the ring connecting to carbon and 5 additional positions obtained by alkylating a secondary amine are possible. If one uses azacrowns with cyclic constraints such as M40403 to reduce flexibility and enhance complex stability, then each cyclohexyl ring gives 6 additional substitution sites (8 cyclohexyl ring hydrogens per ring minus 2 methylene hydrogens), each requiring its own synthetic pathway. The pyridyl ring actually reduces the number of substituent positions by two (3 ring hydrogens minus 4 methylene hydrogens minus one nitrogen hydrogen) while dramatically enhancing rigidity. This versatility of off line substituent location combined with the use of different metals to perturb the template conformation offers a significant advantage in optimizing interactions with a receptor site. This is based on an analysis of the 15-membered ring system that could be expanded to a 16-membered ring by the use of a single β-amino acid, or reduced to a 14-membered ring system through incorporation of a betidamino acid. Rivier et al., Betidamino acids: versatile and constrained scaffolds for drug discovery, Proc. Natl. Acad. Sci. USA, 93:2031-2036 (1996). The versatility of the chemistry involved in this aspect of the invention provides many avenues for exploration of potential conformational scaffolds. The preorganization approach of Neumman et al. to incorporate residues such as 1,2-diaminocyclohexane (DACH) to orient the ends of the peptide for cyclization may be used. Neumann et al., Synthesis of Conformationally Tailored Pentaazacyclopentadecanes. Preorganizing Peptide Cyclizations, Tetrahedron Lett. 38:779-782 (1997). This can be accomplished with proline or pipecolic acid derivatives as well. In these cases, access to chimeric amino acids with appended side-chain groups are known in the art. Kolodziej et al., Ac-[3- and 4-alkylthioproline31]-CCK4 analogs: synthesis and implications for the CCK-B receptor-bound conformation, J. Med. Chem., 38:137-149 (1995); Kolodziej et al., Stereoselective Syntheses of 3-Mercaptoproline Derivatives Protected for Solid Phase Peptide Synthesis, International Journal of Peptide & Protein Research (1996); Makara et al., A Facile Synthesis of 3-Substituted Pipecolic Acids, Chimeric Amino Acids, Tetrahedron Lett. 38:5069-5072 (1997). Essentially, all 25 positions on the azacrown are synthetically accessible for side-chain placements.

Much more rigid PACs such as M40403 are available through metal-templated enantioselective syntheses as optimized by Riley et al. Cornille et al., Electrochemical cyclization of dipeptides toward novel bicyclic, reverse-turn peptidomimetics: Synthesis and conformational analysis of 7,5-bicyclic systems, J. Am. Chem. Soc., 117:909-917 (1995); Riley et al., Rational Design of Synthetic Enzymes and Their Potential Utility as Human Pharmaceuticals: Development of Mangenese(II)-Based Superoxide Dismutase Mimics, Adv. Supramolecular Chem. 6:217-244 (2000). Considering the molecular formula of M40403, C₂₁N₅H₃₅, there are 35 hydrogens that are potential side-chain positions. Some, such as the p-position of the pyridine ring is M40403, are readily accessible. Riley et al., Radical alternatives, Chem. Britain 36:43-44 (2000); Udipi et al., Modifications of inflammatory response to implanted biomedical materials in vivo by surface bound superoxide dismutase mimics, J. Biomed. Materials Res. 51:549-560 (2000). Others would require purchase or synthesis of appropriately derivititized cyclohexane diamines. Such compounds will be entered into the virtual database and synthesis of any particular derivative evaluated on a case-to-case basis.

Each PAC may be complexed with a variety of metals and assayed against the current target of interest. Stability of the complex under assay conditions may be determined by HPLC and/or MS analyses. All Mn(II) and Fe(III) complexes may be assayed for SOD activity. This will allow the elimination of compounds whose activity in a bioassay may be compromised by enzymatic activity. Any other metal PAC complex showing biological activity may be assayed for SOD and catalase activities as well. While the use of metal complexes of azacrowns as conformational templates is a preferred embodiment of this invention, the complexes themselves may be potential therapeutic candidates depending on their stability. Stability of these azacrown complexes depends on ring size, metal complexed, and substituent pattern. Riley et al. have shown dramatic increases in the stability (log K>17 compared with a log K=10.7 for the parent unsubstituted complex) of Mn(II) complexes of PACs using cyclic substituents such as 1,2-diaminocyclohexane (DACH). Riley D P, Functional Mimics of Superoxide Dismutase Enzymes as Therapeutic Agents, Chem. Rev. 99:2573-2587 (1999).

In one embodiment, the invention provides for the creation of a database or library of potential relative orientations of side chains of peptides, cyclic peptides, chiral azacrown and other peptidomimetic complexes for utilization in the methods of this invention. This invention provides comprehensive conformational studies, preferably of cyclic peptides, such as cyclopentapeptides and of metal-complexes of azacrowns as conformational templates for pharmacophore elucidation. In particular, the invention provides for the development of conformational structures for CTPs and CPPs differing in the local steric environment of the backbone, i.e., the variety of conformers obtained by various combinations of Gly, Ala, D-Ala, Aib, Pro, D-Pro, N-Me-Ala and D-N-Me-Ala (number of CPPs=85=32,768). Towards that end, the invention provides for the set of low-energy conformers for diverse examples, focusing on the more conformationally restricted, of these CTPs and CPPs by utilizing energy calculations employing the ECEPP force field. Nikiforovich G V, Computational Molecular Modeling in Peptide Design, Int. J. Peptide Protein Res., 44:513-531 (1994). The sets of low-energy conformers of, e.g., CTPs and CPPs with distinctly different conformational possibilities are then analyzed, as well as those with clearly pronounced conformational elements, such as various β-turns, γ-turns, etc. with highly preferred conformations. The conformers identified may be verified experimentally as well as by computation with quantum mechanics (AMSOL, DFT), molecular mechanics with different force fields, solvation models (both explicit and implicit), and methodology (potential smoothing, MC/MD, etc.) and discrepancies noted in the Database.

In a further embodiment, the information regarding these templates is provided in a database for searching and use in the process of drug design. The information in this database or library may be used for validating hypotheses on three-dimensional model(s) of a pharmacophore for a given fragment of the peptide, chiral azacrown or peptidomimetic. Libraries can then be created containing such conformational templates with e.g., different sets of low-energy conformers, each of which are capable of positioning side chains in a desired three-dimensional orientation. Then the corresponding preferred CTPs, CPPs and/or PACs can be synthesized on the basis of the selected templates and subjected to biological testing. The resulting biological data ensures the reliable and efficient validation of the hypothesis, since the same types of three-dimensional structures will be presented differently (by different positions in the sequence) in different conformationally constrained compounds.

The database or library of the invention may also be used to create new three-dimensional model(s) of a pharmacophore for a given fragment of a peptide, chiral azacrown or peptidomimetic. In this case, the library is used as source of model CTPs, CPPs and PACs featuring the set of different low-energy conformers that may be checked as possible three-dimensional model(s) of the receptor-bound conformation. Again, the corresponding compounds can be synthesized on the basis of the selected templates and subjected to biological testing. The results are used to direct the further rational design of new peptides and peptidomimetics.

Additionally, the library may be used for guiding synthetic paths to the desired CTPs, CPPs and PACs. The library may contain the synthetic protocols for each CTP, CPP and PAC synthesized and be used to synthesize any new CPP or PAC similar to those already included in the library.

Furthermore, the database may provide routine NMR data, such as the primary assignments of NMR peaks, for many CTPs, CPPs and PACs. As with synthetic data, the database may include the NMR data obtained for various CTPs, CPPs and PACs. This information may be helpful in interpreting NMR data for newly synthesized CPPS or PACs.

In a further aspect of the invention, conformational analysis of the peptides, including preferred cyclic peptides and their analogs, peptidomimetics and chiral azacrowns may be employed. All low-energy conformers for the backbone of a short peptide can be elucidated by independent energy calculations, which then may be evaluated as members of the ensemble of candidate conformations. Moreover, the combined use of the independent NMR measurements and energy calculations allows an estimation of statistical weights for the actual conformers observed in solution. Energy calculations can explore the entire conformational space available for any CPP, and determine all low-energy conformers for its backbone. At the same time, the calculated sets of low-energy conformers can be validated by NMR spectroscopy and/or X-ray crystallography.

As an example, 11 crystal structures of PACs with different substituent patterns and complexed with 3 different metals (Mn, Fe, Cd) were examined to compare the relative orientations of side chains with those seen in parent CPPs or other structures of interest such as β-turns. Riley et al., Synthesis, Characterization, and Stability of Manganese(II) C-Substituted 1,4,7,10,13-Pentaazacyclopentadecane Complexes Exhibiting Superoxide Dismutase Activity. Inorg. Chem., 35:5213-5231 (1996); Zhang et al., Iron(III) Complexes as Superoxide Dismutase Mimics: Synthesis, Characterization, Crystal Structure, and Superoxide Dismutase (SOD) Activity of Iron(III) Complexes Containing Pentaaza Macrocyclic Ligands. Inorg. Chem., 37:956-963 (1998). A CADD tool FOUNDATION was used to find overlap of the vectors corresponding to side-chain orientations between ideal β-turn conformations and the crystal structure of the PAC metal complexes. Ho et al., FOUNDATION: A program to retrieve subsets of query elements, including active site region accessibility, from three-dimensional databases. J. Comput. Aided Mol. Des., 7:3-22 (1993) For example, in one situation where the Mn(II) complex of an unsubstituted penta-azacrown orients the side-chain substituents exactly as those seen for the i and i+1 residue of an ideal type β-turn. As a peptidomimetic of this turn, this example suffers from the fact that only two side chains are oriented correctly and there is a significant difference in volume overlap. Nevertheless, if only the two side chains that correctly overlap are involved in receptor recognition, then the Mn-complex should show activity. Different metals have different van der Waals radii and, therefore, require different distances between the metal and the inner-sphere nitrogens. The average distance seen in the crystal structures of PAC-metal complexes that have been analyzed so far is 2.271 for Fe(III)-N, 2.283 for Mn(II)-N, and ? for Cd(II)-N distance. Riley et al., Computer-Aide Design (CAD) of Synzymes: Use of Molecular Mechanics (MM) for the Rational Design of Superoxide Dismutase Mimics. Inorg. Chem., 38:1908-1917 (1999). Thus, each metal flexes the PAC ring differently resulting in different fixed orientations of the side-chain position for each conformer.

The conformational analysis of the invention may utilize any method known in the art to ensure that any conclusions regarding the three-dimensional conformation of these peptides or analogs, or chiral azacrowns, are not force field, parameter, or algorithm dependent. The approach exemplified in Nikiforovich et al. on CPPs using the ECEPP force field and a systematic search approach may be applied initially. Nikiforovich et al., Combined use of spectroscopic and energy calculation methods for the determination of peptide conformation in solution. Biophys. Chem., 31:101-106 (1988). Alternatively, the MC/MD method of MacroModel with the GB/SA solvation model for conformational analysis on reverse-turn mimetics may be applied as well. Chalmers, et al., Pro-D-NMe-Amino and D-Pro-NMe-Amino Acid: Simple, Efficient Reverse-Turn Constraints. J. Am. Chem. Soc., 117:5927-5937 (1995); Takeuchi et al., Conformational Analysis of Reverse-Turn Constraints by N-Methylation and N-Hydroxylation of Amide Bonds in Peptides and Non-Peptide Mimetics. J. Am. Chem. Soc., 120:5363-5372 (1998). Recently, diffusion equation approach has been extended to include an implicit GB/SA solvation model. Pappu et al., Analysis and application of potential energy smoothing and search methods for global optimization. J. Phys. Chem. B., 102:9725-9742 (1998); Pappu et al., A potential smoothing algorithm accurately predicts transmembrane helix packing. Nature Struct. Biol., 6:50-55 (1999). Those conformational mimina consistently identified assumed to be most likely may be used. In order to verify the minima obtained, they may be used as input to both AMSOL and DFT minimizations.

A number of factors need to be weighed to determine which compounds should be made and tested for a given biological screen, such as the stage of development of the project at hand, e.g., lead discovery or lead optimization. For lead discovery, one may explore potential side-chain orientations broadly, so compounds that present similar side-chain orientations should be clustered and only a representative sample assayed to allow for the most efficient exploration of possibilities. Once a lead is found, then one may concentrate on compounds with similar side-chain orientations to that lead to optimize its affinity.

According to the invention, more than one database or library for virtual compounds may be used to manage the combinatorial complexity and guide the selection of compounds for synthesis. For example, a conformational-template database of ring conformers available to different chiral configurations of cyclic pentapeptides (CPPs), for example, c(aAAaA) or cyclic (D-Ala-Ala-Ala-D-Ala-Ala) may be used. Using cyclic penta-alanine as a model, one only has to consider 32 compounds. Preferably, compounds in which some rigidity has been introduced may be employed to simplify the conformational ensemble available to the peptide and require that one position be occupied by a proline (either D or L) or an Aib. If proline or a N-Me-amino acid is used, then consideration of both amide bond isomers (cis or trans) should be given in the conformational analysis. For example, if one assumes that the base analysis is done only on Aib- and Ala-containing CPPs, this means that 243 (3⁵) conformational analyses of CPPs containing Ala or Aib would be performed. For each, the minima detected within 5 kcal/mol of the global will be associated with compound and a CAVEAT-like analysis of α-β vectors that represent possible side-chain orientations entered for each conformer. Lauri et al., CAVEAT: A program to Facilitate the Design of Organic Molecules. J. Comput.-Aided Mol. Des., 8:51-66 (1994). The database may be inverted and organized by distance Dα between β-carbons, then distance Dβ between β-carbons, torsion angle ω (β1-α1-α2-β2), etc. to provide readily accessible and efficient comparisons and clustering. The analysis for mono- and di-substituted DACH and pyridyl CPPs may be performed as well, as they would significantly reduce conformational flexibility. The different size rings and geometrical constraints provide significant diversity in side-chain orientations available to libraries of such compounds.

Libraries of the present invention may have several uses. For example, one may characterize the diversity in the conformational templates synthetically accessible and select a diverse set as screening templates. Once a hit has been found, templates that have similar side-chain orientations may be selected. For a given hit, templates may have several conformations with different side-chain orientations, so other templates that can only overlap one or a limited number of side-chain orientations may be selected for synthesis and screening. In this way, one may quickly resolve the side-chain orientation associated with such activity. Third, once a hypothetical side-chain orientation for molecular recognition has been suggested, the set of conformational templates capable of a similar orientation may be readily ascertained and evaluated for screening using the methods of this invention.

As stated above, the invention contemplates the use of more than one database or library for virtual compounds to manage the combinatorial complexity and to guide the selection of compounds for synthesis. For example, a second more limited database, may be constructed for known or postulated pharmacophoric orientations of specific side-chain groups, such as phenyl, phenol, indole, carboxyl, guanidinium, carboxyamide, etc. A more complex assessment may be made of which conformational templates are capable of locating these functional groups in the appropriate three-dimensional geometrical pattern. There are more degrees of torsional freedom (χ1, χ2, etc.) associated with localizing the side chains in a particular area of three-dimensional space. Three-dimensional pharmacophoric patterns for recognition at certain GPCR receptor subtypes have been previously determined (AII, opioid, CCK, gastrin, bradykinin, neurokinin, etc.).

The virtual database may be used to include the PACs complexed with different metals. One limitation with this approach is the difficulty of representing ligand-field forces of transition metals by molecular mechanics that could be addressed by DFT calculations. However, a force-field has been calibrated for copper and is being extending to other transition metals as well. Carlsson A E., Angular and Torsional Forces Via Quantum Mechanics. Journal of Phase Equilibria, 18:60-613 (1997); Carlsson A E., Angular Forces around Transition Metals in Biomolecules. Physical Review Letters, 81:477-480 (1998). Riley et al. have that the force field in CAChe produces good geometries and relative energies for Mn, Zn, and Fe when the parameters are calibrated. Riley D P., Functional Mimics of Superoxide Dismutas Enzymes as Therapeutic Agents. Chem. Rev., 99:2573-2587 (1999); Riley D P., Rational Design of Synthetic Enzymes and Their Potential Utility as Human Pharmaceuticals: Development of Manganese(II)-Based Superoxide Dismutase Mimics. Adv. Supramolecular Chem., 6:217-244 (2000). Similar results have been obtained with Fe(III) complexes of enterobactin analogs after adjusting parameters in MacroModel to reproduce crystal structures. Several series of compounds may be made with a single PAC complexed with different metals (Mn, Fe, Cd, Zn, Gd, Co, Mb, etc.) and the crystal structures may be obtained to help calibrate force field parameters, and to determine the range of structural perturbation seen upon complexation search methodology. Again, prescreening of the virtual library based on the conformational-template database will help determine which metal complexes are actually prepared and screened.

The libraries and methods of this invention may be used to determine the three-dimensional pharmacophores for biologically active peptides and for use in drug development. Examples of uses with various enzymes and receptors are provided below.

Certain enzymes whose predicted complexes can be readily confirmed by NMR or crystallography are known. For this reason, α-amylase was selected as target based on the work of Tien and Bartlett, as well as the preceding work on cyclic peptide inhibitors based on the structure of the Trp-Arg-Tyr β-turn segment of the proteinaceous inhibitor tendamistat. Tian et al, Metal Coordination as a Method for Templating Peptide Conformation. J. Am. Chem. Soc., 118:943-949 (1996); Etzkorn et al, Cyclic Hexapeptides and Chimeric Peptides as Mimics of Tendamistat. J. Am. Chem. Soc., 116:10412-10425 (1994). Another enzyme which is known is HIV protease. In this case, we developed a high-throughput fluorescent assay have been used to screen compound libraries for inhibitors. Toth et al., A simple, continuous fluorometric assay for HIV protease. Int. J. Pep. Prot. Res., 36:544-550 (1990). In this case, we also have methods for predicting the affinity of complexes of potential inhibitors with HIV protease that can be used to help screen a virtual library. Waller et al., 3-D QSAR of human immunodeficiency virus (I) protease inhibitors. I. A CoMFA study employing experimentally-determined alignment rules. J. Med. Chem, 36:4152-4160 (1993); Head et al., VALIDATE-a new method for the receptor-based prediction of binding affinity of novel ligands. J. Am. Chem. Soc., 118:3959-3969 (1996). Crystal structures of a wide variety of compounds complexed with the enzyme available in the PDB allow for targeting and evaluation of CPPs and PACs capable of mimicry of known complexes.

Another well-researched biologically active peptide, the triad Arg-Gly-Asp (RGD) interacting with integrin receptors may be used in this invention. This has been a therapeutic target for industrial drug development as well as the system studied by Kessler and co-workers and, most recently, in the β-amino acid cyclic pentapeptide analogs of Schumann et al. Kopple et al., Conformationals of Arg-Gly-Asp Containing Heterodetic Cyclic Peptides: Solution and Crystal Studies. J. Am. Chem. Socl., 114:9615-9623 (1992); Ali et al., Conformationally constrained peptides and semipeptides derived from RGH as potent inhibitors of the platelet fibrinogen receptor and platelet aggregation. J. Med. Chem., 37:769-780 (1994); Cheng et al., Design and Synthesis of Novel Cyclic RGD-Containing Peptides as Highly Potent and Selective Integrin α_{IIb}β₃ Antagonists. J. Med. Chem., 37:1-8 (1994); McDowell et al., From Peptide to Non-Peptide. 2. The de Novo Design of Potent, Non-Peptide Inhibitors of Platelet Aggregation Based on a Benzodiazepinedione Scaffold. J. Am. Chem. Soc., 116:5077-5083 (1994); Pfaff et al., Selective recognition of cyclic RGD peptides of NMR defined conformation by α_{IIb}β₃, αV\pard f4 b3 and α5β1 Integrins. J. Biol. Chem., 269:20233-20238 (1994); Haubner et al., Cyclic RGD Peptides Containing β-Turn Mimetics. J. Am. Chem. Soc., 118:7881-7891 (1996); Haubner et al., Structural and Functional Aspects of RGD-Containing Cyclic Pentapeptides as Highly Potent and Selective Integrain αvβ3 Antagonists. J. Am. Chem. Soc., 118:7461-7472 (1996); Schumann et al., β-Amino Acids γ-Turn Mimetics? Exploring a New Design Principle for Bioactive Cyclopeptides. J. Am. Chem. Soc., 122:12009-12010 (2000).

Peptide hormone systems such as TRH, α-MSH, CRF, bradykinin and somatostatin, where we have hypotheses of the receptor-bound conformation may also be used in this invention. Using databases constructed for the virtual libraries, one may select a few compounds for synthesis that overlap proposed pharmacophores. For example, c(His-D-Phe-Arg-Trp-Aib) is a candidate for the α-MSH receptor. For the CRF receptor, c(Gln-Ala-His-Ser-Asn) is an initial candidate. For somatostatin, the CPP candidate may be(Phe-D-Trip-Lys-D-Thr-Aib). The database provided may be searched for PACs and other classes of compound that can overlap the proposed pharmacophores as well.

Additionally, this invention may be utilized for the refinement in optimizing the side-chain orientations for enhanced affinity on the lead CPP and PAC scaffold and may be directly translated to other scaffold (e.g. benzodiazepines, etc.) through the use of programs such as FOUNDATION and CAVEAT and databases such as the TRIAD and ILLIAD analyzing substituent orientations complied for such purposes by the Bartlett group. Lauri et al., CAVEAT: A program to Facilitate the Design of Organic Molecules. J. Comput.-Aided Mol. Des., 8:51-66 (1994); Ho et al., FOUNDATION: A program to retrieve subsets of query elements, including active site region accessibility, from three-dimensional databases. J. Comput. Aided Mol. Des., 7:3-22 (1993); Bartlett Pea, TRIAD and ILLIAD three-dimensional Databases. Edited by Berkeley, Calif. 94704: Office of Technology Licensing—Berkeley (1993).

The detailed description set-forth above is provided to aid those skilled in the art in practicing the present invention. Even so, this detailed description should not be construed to unduly limit the present invention as modifications and variation in the embodiments discussed herein can be made by those of ordinary skill in the art without departing from the spirit or scope of the present inventive discovery.

All publications, patents, patent applications and other references cited in this application are herein incorporated by reference in their entirety as if each individual publication, patent, patent application or other reference were specifically and individually indicated to be incorporated by reference.

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

### EXAMPLE 1

### Receptor-Bound Conformation and Peptidomimetics

Cyclopentapeptides were prepared according to G. V. Nikiforovich, K. E. Kover, W., J. Zhang, and G. R. Marshall, Cyclopentapeptides as Flexible Conformational Templates for Receptor Probes. J. Am. Chem. Soc., 2000, 122, 3262 (Appendix).

The first priority was to validate the use of the ECEPP force field for conformational studies of isolated CPPS. Energy calculations for seven cyclopentapeptides with known X-ray structures starting from two model sequences, cyclo(Gly-Pro-Gly-Gly-Pro) and cyclo(Gly-Pro-Gly-Gly-Ala), explored all combinations of local energetic minima of all amino acid residues in both sequences, including the trans/cis conformers for Pro residues. Low-energy conformers geometrically similar to the X-ray structures were found in all cases. Notably, two cases with the ω12 angle in the cis-conformation [c(APGfP) and c(GPfAP)] were reproduced. Some peptide bond planes are rotated in the calculated low-energy conformers compared to the corresponding X-ray structures [C(APGfP), c(GPfGA) and c(CPfGV)]. In all theses cases, strong hydrogen bonds between adjacent molecules were observed within the crystal cells). Karle et al., Variability in the backbone Conformation of Cyclic pentapeptides, Int. J. Pept. Prot. Res. 28:420-427 (1986); Stroup et al., Crystal Structure of cyclic(Gly-L-Pro-D-Phe-Gly-L-Val): An Example of a new Type of Three-Residue Turn, J. Am. Chem. Soc. 109:7146-7150 (1987); Gierarsch et al., Crystal and Solution structure of cyclo)Ala-Pro-Gly-D-Phe-Pro): A New Type of Cyclic Pentappeptide Which Undergoes Cis-Trans Isomerization of the Ala-Pro Bond, J. Am. Chem. Soc. 107:3321-3327 (1985).

The next step demonstrated that independent energy calculations produce much more reliable conclusions on three-dimensional structure(s) of cyclopentapeptides than those deduced from NMR data by energy minimizations with imposed NMR restraints. Cyclo(D-Pro¹-Ala²-Ala³-Ala⁴-Ala⁵)[c(pAAAA)] peptide whose three-dimensional structures in DMSO were studied with the latter approach by the Kessler group earlier. Mierke et al., Peptide flexibility and calculations of an ensemble of molecules, J. Am. Chem. Soc. 116:1042-1049 (1994). As the final result, five possible three-dimensional structures were proposed for c(pAAAA). Mierke et al., Peptide flexibility and calculations of an ensemble of molecules, J. Am. Chem. Soc. 116:1042-1049 (1994). All of them are the same βII′γ type containing the βII′ turn encompassing the D-Pro¹-Ala² fragment, and differing in the conformations of Ala⁴, the residue in the “γ” position of the cyclopentapeptide. The Φ, Ψ values of the Alain⁴ for these five structures are as follows (90, −60); (0, −60); (−120, −60); (30,120); (−170,120). These results did not seem realistic, since it is highly unusual to find a residue of the L-configuration in a conformation with positive Φ and negative Ψ values (a “forbidden” region of the Ramachandran plat for L-Ala). None of the known X-ray structures of cyclopentapeptides possess this feature. Moreover, in all known X-ray structures, the residue in the “γ” position possesses an actual “inverted γ-turn” values for Φ, Ψ. (ca. −70, 70) only if it is Pro. Also, all known “γ-turn” values (ca. 70, −70) belong to a D-Ala residue.

The independent energy calculations for c(pAAAA) include 3,985 peptide conformers geometrically allowed to close the pentapeptide ring, each subjected to energy minimization. Five of them possessed relative energies 5 kcal/mol, the criterion used for selection of the “low-energy” three-dimensional structures. None of the structures possess the pronounced βII′ turn in the D-Pro¹-Ala² region, but all of them are geometrically similar to the discussed βII′γ type.

The calculated low-energy three-dimensional structures of c(pAAAA) are consistent with the NMR data of the Kessler group. For comparison, the approach developed earlier was used, which points out that experimentally measured and calculated parameters are in good agreement when their mean values are statistically indistinguishable. Nikiforovich et al., Combined Use of spectroscopic and energy calculation methods for the determination of peptide conformation in solution, Biophys. Chem. 31:101-106 (1998).

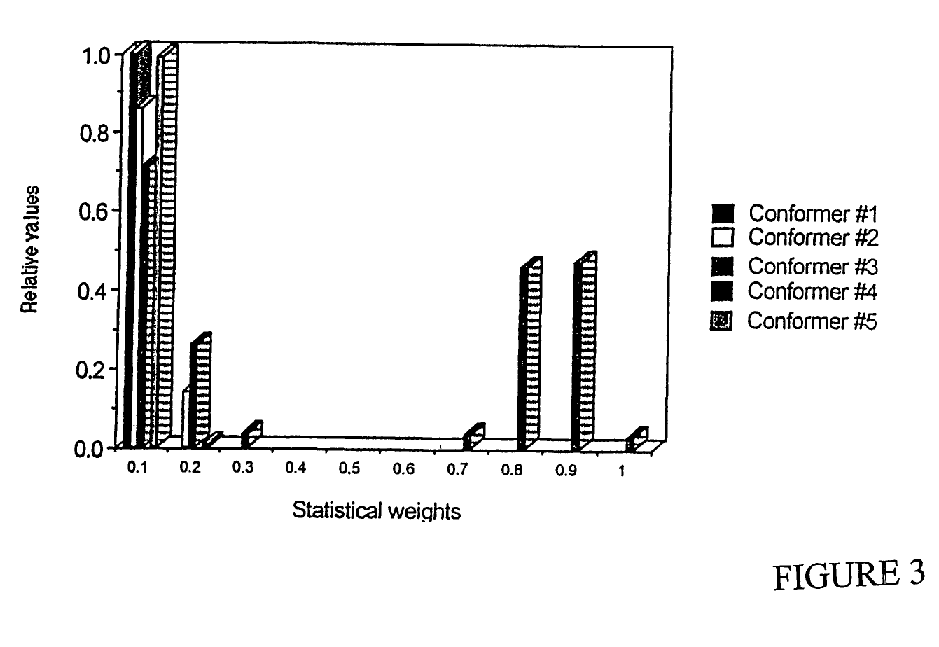

Summarizing, independent energy calculations were able to find a family as shown in FIG. 3 of low-energy three-dimensional structures for c(pAAAA), consistent both with the NMR data and with available X-ray data on CPPs. (While one conformer is predominant in DMSO solution, it may be not the conformer that participates in the peptide-receptor complex.) Contrary to the Kessler group, it was found that the preferred Ala⁴ conformations in solution are in the regions corresponding either to right, or to left α-helices.

The Aib residue (aminoisobutyric acid, α-methylalanine, MeA) is known to limit conformational flexiblity of the backbone either to the right-, or to left-handed α-helix. Marshall G R, A Hierarchical Approach to Peptidomimetic Design, Tetrahedron 49:3547-3558 (1993). Applicants studies of c(pAAAibA) demonstrated the efficiency and reliability of the independent energy calculations for conformational studies of CPPs. Energy calculations for c(pAAAibA) include 2,840 peptide conformers geometrically allowed to close the pentapeptide ring. Four of them had been shown to possess relative energies 5 kcal/mol. The Aib⁴ residue in the four conformers possesses the Φ, Ψ values as follows: (59, 20); (70, 14); (171, −37); (−61, −31). Again, none of the structures possesses the pronounced βII′ turn in the D-Pro¹-Ala² region, but all of them are gametically similar to the βII′γ type. After energy calculations confirmed that the low-energy conformers of the c(pAAAibA) peptide retained either right-, or left-handed α-helix as the preferential conformations for the Aib⁴ residue, c(pAAAibA) was synthesized with a reasonable overall yield (36%) and its structure in DMSO examined by NMR. All TOCSY, NOESY and ROESY spectra showed the presence of highly ordered three-dimensional structures with the negligible amount of the cis-conformer (the Ala⁵-D-Pro¹ peptide bond).

The best-known case employing NMR spectroscopy in elucidating CPP pharmacophores is the pioneering work on RGD-containing CPPs by the Kessler group. They have found that both c(RGDfV) and c(RGDFv) are almost equally potent inhibitors of binding α_{IIb}β₃ integrins to fibrinogen and αᵥβ₃ integrins to vitronectin (with affinities of a few hundreds nanomolar. Pfaff et al., Selective Recognition of Cyclic RGD Peptides of NMR Defined Conformation by αIIbβ3, αVβ3, α5β1 Integrins, J. Biol. Chem. 269:20233-20238 (1994); Gurrath et al., Conformational/activity studies of rationally designed potent anti-adhesive RGD peptides, Eur. J. Biochem. 210:911-921 (1992); Aumailley et al., Arg-Gly-Asp constrained within cyclic pentapeptides, FEBS Letters 291:50-54 (1991). However, since both peptides, according to their interpretation of the NMR data should possess a single conformation of the βII′γ type, the conformations of the active sequences, RGD, must be dissimilar in these two peptides. Aumailley et al., Arg-Gly-Asp constrained within cyclic pentapeptides, FEBS Letters 291:50-54 (1991). The discrepancy was explained by a postulated similarity of the spatial arrangements of the C^{α}-C^{β} vectors Arg and Asp in both peptides. Muller et al., Pharmacophore refinement of gpIIb/IIIa antagonists based on comparative studies of antiadhesive cyclic and acyclic RGD peptides, J. Comp-Aided Mol. Design, 8:709-730 (1994). However, the authors noted that the results of their “vector analysis” were not in agreement with the three-dimensional model for the RGD pharmacophore confirmed by X-ray studies. Kopple et al., Conformation of Arg-Gly-Asp Containing Heterodetic Cyclic Peptides: Solution and Crystal Studies, J. Am. Chem. Soc. 114:9615-9623 (1992). Moreover, introduction of a rigid peptidomimetic element stabilizing the suggested βII′γ type structure resulted in the complete loss of inhibition of binding α_{IIb}β₃ integrins to fibrinogen and αᵥβ₃ integrins to vitronectin, whereas stabilizing a different three-dimensional structure yielded the best compound. Haubner et al., Cyclic RGD Peptides Containing β-Turn Mimetics, J. Am. Chem. Soc. 118:7881-7891 (1996). Therefore, the finding that c(RDG″R-ANC″) showed excellent inhibition of virtronectin binding to the αᵥβ₃ receptors (IC₅₀=0.85 nM[30]), cannot be ascribed to the success of rational drug design using CPPs as conformational templates by the Kessler group.

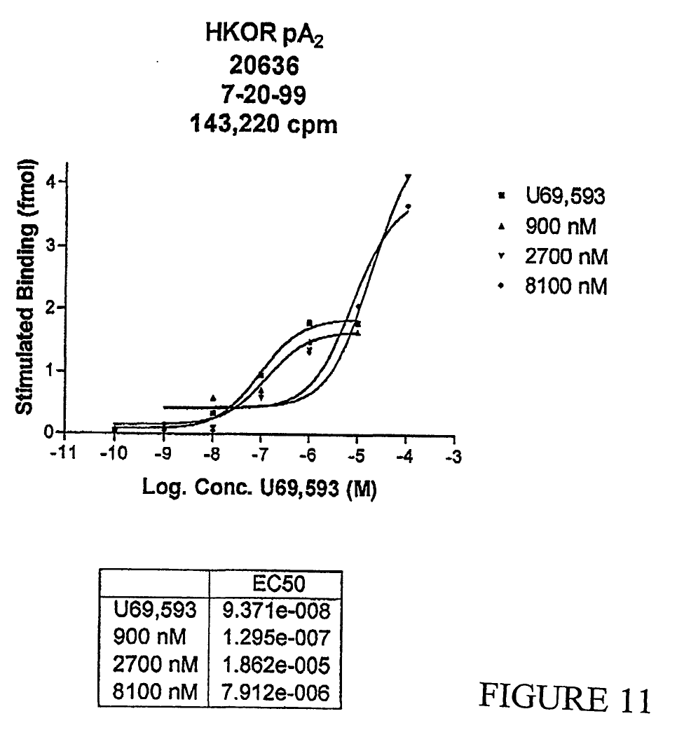

On the other hand, the energy calculations revealed seven low-energy backbone conformer (ΔE 5 kcal/mol) for c(RGDfV), and six low-energy backbone conformers for c(RGDFv). It appeared that all six conformers together satisfy the NMR data, all mean statistical weight values being of 0.15-0.18. Geometrical similarity of low-energy conformers for c(RGDfV) and c(RGDFv) (i.e., comparing 42 pairs of conformers) achieved the best fit of spatial arrangements of the C^{α} and C^{β}atoms for the RGD sequence and of the C^{α} atoms for the L/D-Phe and L/D-Val residues. The distance between all seven corresponding atoms were less than 0.50 only for one pair of conformers. Overlap of these conformers is depicted in FIG. 12 which can be regarded as the three-dimensional pharmacophore model for RGD-containing CPPs devoid of any discrepancies, and in good agreement with the model for the RGD pharmacophore proposed by other authors Kopple et al., Conformation of Arg-Gly-Asp Containing Heterodetic Cyclic Peptides: Solution and Crystal Studies, J. Am. Chem. Soc. 114:9615-9623 (1992).

### EXAMPLE 2

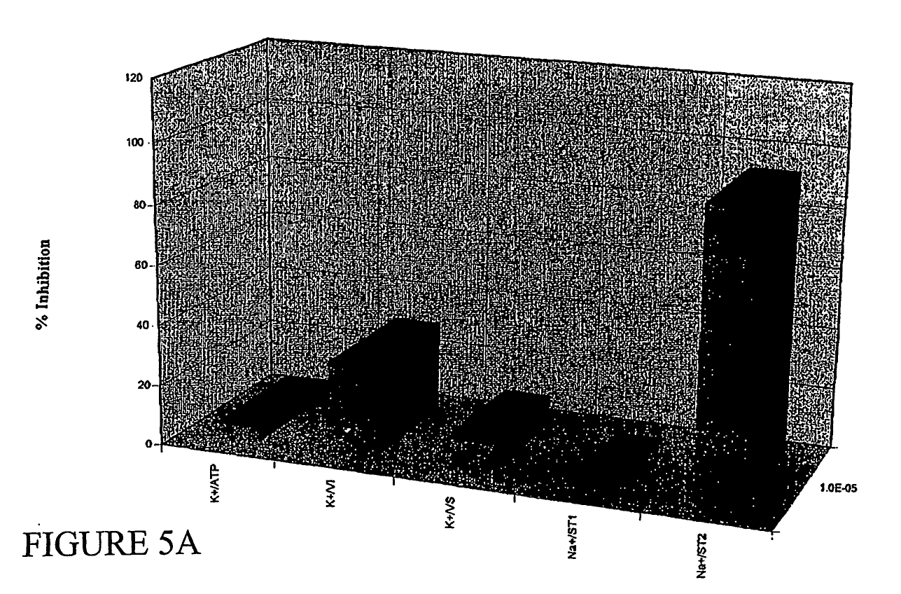

Evaluation of M40403 and M40401 in the following radioligand binding assays: potassium channels (ATP-sensitive, Ca2+Act., VI, potassium channel, CA2+Act., VS) and sodium channels (site 1 and site 2). M40403 and M40401 were tested at a single does of 10 □M. The list of an appropriate radioligand used in each ion channel assay is shown in Table 1. Results show significant inhibition of the sodium channel site 2 (84.76% inhibition for M40403 and 93.84% inhibition for M40401). These results are shown in FIGS. 5(a) and 5(b) and summarized in Table 2.

TABLE 1
List of Radioligand used in Ion Channel Assay

| | | | | | | |
|---|---|---|---|---|---|---|
| | Assay | | | Reference | Ki (M) Ref. | |
| Assay | Abbr | Radioligand | Kd(M) | Compound | Cpd. | Activity |

ION CHANNELS

| | | | | | | |
|---|---|---|---|---|---|---|
| Potassium | K+/ATP | [3H]Glibenclamide | 0.25E−9 | Glibenclamide | 7.85E−10 | No |
| Channel, ATP- | | | | | | |
| Sensitive | | | | | | |
| Potassium | K+/VI | [125I]Apamin | 7.0E−11 | Apamin | 5.05E−11 | No |
| Channel, Ca2 + Act, | | | | | | |
| VI | | | | | | |
| Potassium | K+/VS | [125I]Charybdotoxin | 1E−10 | Charybdotoxin | 5.12E−10 | No |
| Channel, Ca2 + Act., | | | | | | |
| VS | | | | | | |
| Sodium, Site 1 | Na+/ST1 | [3H]Saxitoxin | 2.2E−9 | Tetrodotoxin | 1.35E−8 | No |
| Sodium Site 2 | Na+/ST2 | [3H]Bactrachotoxin | 32.0E−9 | Aconitine | 8.38E−7 | Yes |
| | | A 20-a-Benzo | | | | |

Activity = greater than or equal to 50% inhibition of binding.

TABLE 2
Results of M40403 Ion Channels Binding Assays
Percent Inhibition
(Average; N = 2)

| | |
|---|---|
| Receptor | 1.0E−5 |

ION CHANNELS

| | |
|---|---|
| Potassium Channel, ATP-Sensitive | 4.67% |
| Potassium Channel, Ca2Act., VI | 30.35% |
| Potassium Channel, Ca2+ Act., VS | 9.72% |
| Sodium, Site 1 | −19.68% |
| Sodium, Site 2 | 93.84% |

TABLE 3
Results of M40401 Ion Channels Binding Assays
Percent Inhibition
(Average; N = 2)

| | |
|---|---|
| Receptor | 1.0E−5 |

ION CHANNELS

| | |
|---|---|
| Potassium Channel, ATP-Sensitive | 5.63% |
| Potassium Channel, Ca2Act., VI | 34.28% |
| Potassium Channel, Ca2+ Act., VS | 15.21% |
| Sodium, Site 1 | −4.00% |
| Sodium, Site 2 | 84.76% |

Screening assays can provide valuable information about a compound's biological activity and selectivity. NOVASCREEN Biosciences Corporation of Hanover, Md. was used for these assays. To understand and assess the data, these guidelines are to be used for interpretation of the data presented:

In most assays, our standard baseline range runs from −20% to +20% inhibition of binding or enzyme activity. NOVASCREEN considers compounds showing results in this range inactive at this site. NOVASCREEN's assays are designed to test for inhibition of binding or enzyme activity. Occasionally, compounds, particularly naturally derived products and extracts, will demonstrate high negative inhibition (i.e., resulting from the extraction procedure used) and may, at the discretion of the client, warrant retesting at lower concentrations. Compounds exhibiting these results show marginal activity at the receptor site and generally do not warrant further examination unless otherwise directed by the client.

NOVASCREEN uses a criteria of 50% inhibition (or greater) to qualify a compound as active. Active compounds tested at multiple concentrations can generally be expected to show a dose-dependent response and such follow-up studies are recommended.

### EXAMPLE 3

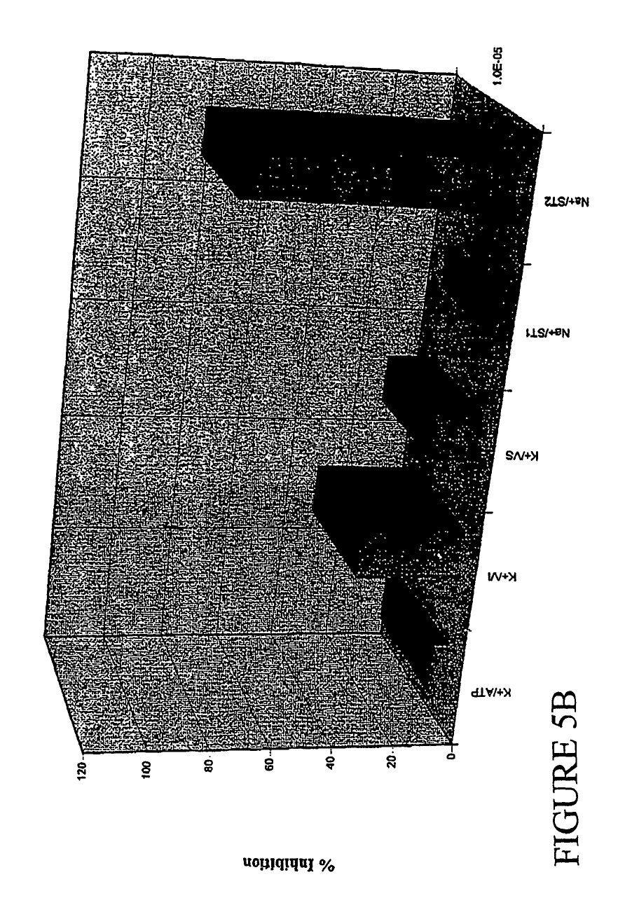

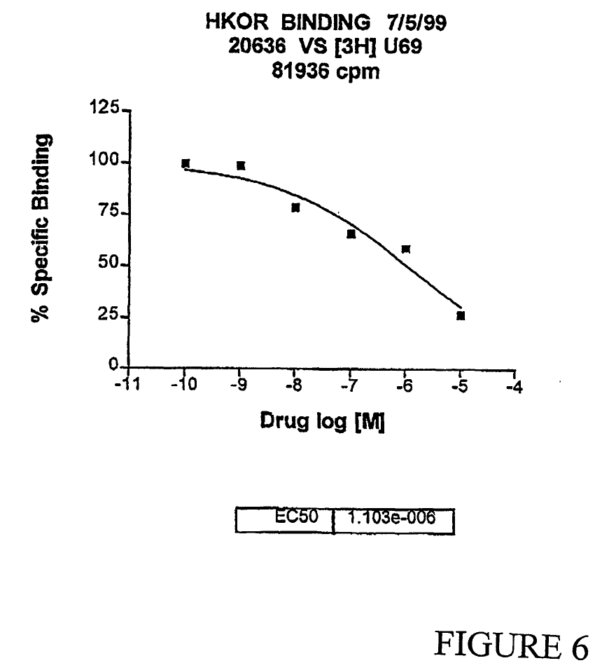

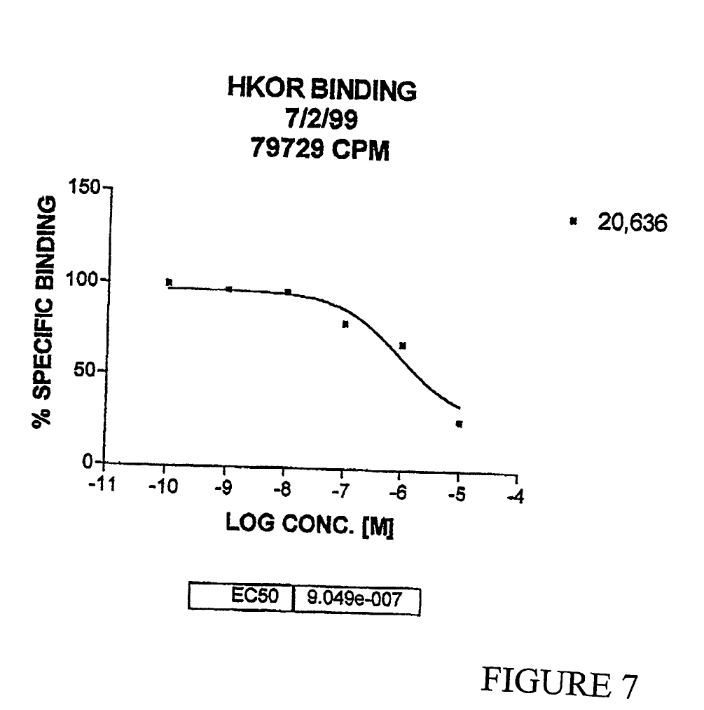

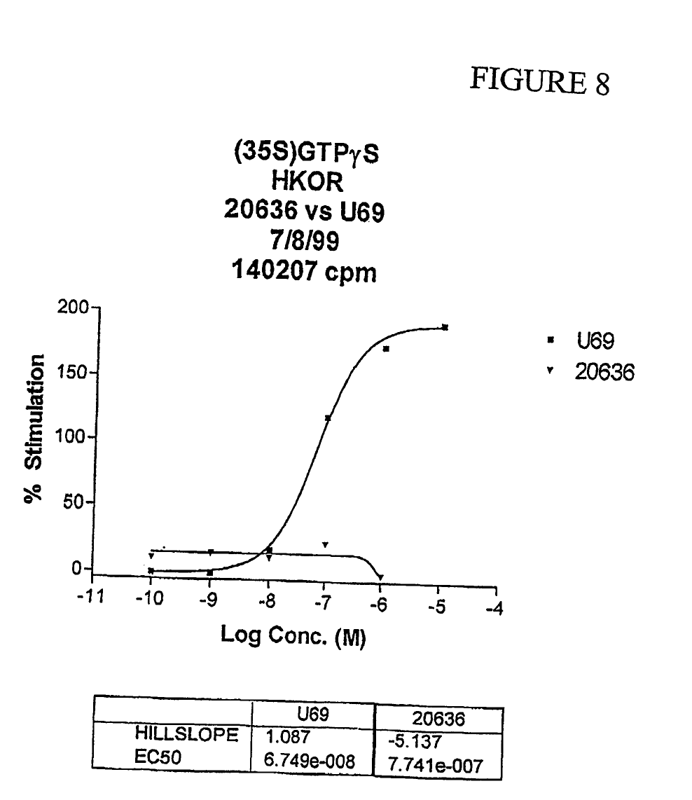

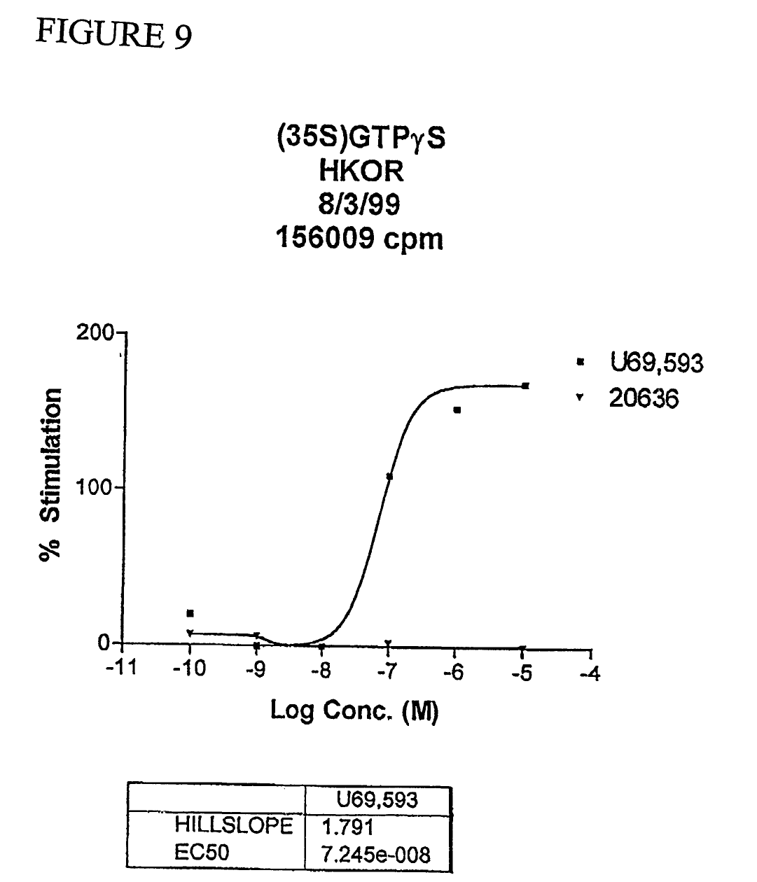

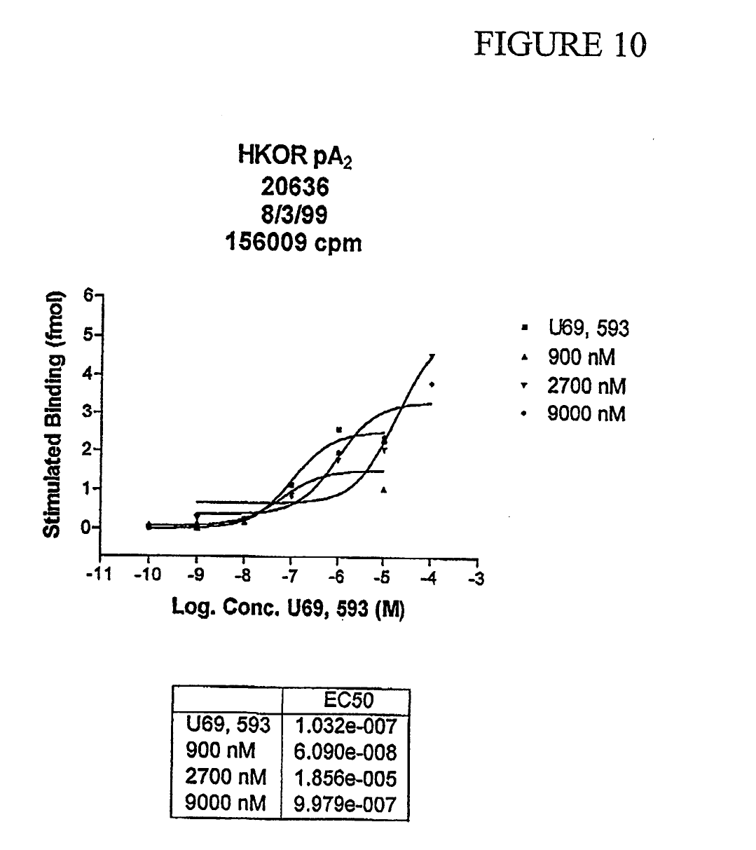

Evaluation of M40403 binding affinity for opioid receptors in vitro radioligand binding assays. Referring to FIGS. 6-11, receptor binding studies were conducted on human opioid receptors transfected into Chinese hamster ovary (CHO) cells. The μ cell line is maintained in Ham's F-12 medium supplemented with 10% fetal bovine serum and 400 μg/ml GENETICIN (G418 sulfate). The δ cell line is maintained in Ham's F-12 medium supplemented with 10% fetal bovine serum and 500 μg/ml hygromycin B. The k cell line is maintained in Dulbecco's minimal essential medium (DMEM) supplemental with 10% fetal bovine serum, 400 μg/ml GENETICIN (G418 sulfate) and 0.1% penicillin/streptomycin. All cell lines are grown to full confluency, then harvested for membrane preparation. The membrane for binding assays is prepared in 50 mM Tris buffer, pH 7.7. Cells are harvested by scraping the plates with a rubber policeman and then centrifuged at 500×g for 10 minutes. The cell pellet is suspended in buffer A or Tris buffer, homogenized in a Polytron Homogenizer, and centrifuged at 20,000×g for 20 minutes. The cell pellet is washed in buffer A or Tris, centrifuged at 20,000×g for another 20 minutes and finally suspended in a small amount of buffer to determine protein content. Membrane is aliquoted in small vials at a concentration of 6 mg/ml per vial and stored at −70° C. and used as needed.

Routine binding assays were conducted using [³H]DAMGO, [³H]C1-DPDPE, and [³H]U69,593 to bind to μ, δ and k receptors, respectively. For μ and δ binding, cell membranes are incubated with the appropriate radioligand and unlabeled drug in a total volume of 200 μl in 96-well plates, usually for 1 hour at 25° C. For k binding cell membranes are incubated in a total volume of 2 ml in tubes rather than plates, as the number of opiate receptors or receptor occupancy in k cell line has not been as high as in other cell lines. For routine experiments, membranes are incubated with the test compounds at concentrations ranging from 10⁻⁵ to 10⁻¹⁰ M. After the incubation, samples are filtered through glass fiber filters by using a Tomtec cell harvester. Filters are dried overnight before radioactivity levels are determined. Nonspecific binding is determined by using 1.0 μM of the unlabeled counterpart of each radioligand.

Full characterization of compounds includes analysis of the data for IC₅₀ values and Hill coefficients by using the program PRIMS. Kᵢ values are calculated using the Cheng Prusoff transformation:

$${K}_{i} = \frac{I {C}_{50}}{1 + L / {K}_{d}}$$

where L is radioligand concentration and K_{d} is the binding affinity of the radioligand, as determined previously by saturation analysis.

TABLE 4
Results of M40403 Opioid Receptor Binding Assays

| | Kᵢ(nM) | | |
|---|---|---|---|
| | μ | δ | k |
| OTDP# | [³H]DAMGO | [³H]C1-DPDPE | [³H]U69,593 |
| 20,636 | >10,000 | >10,000 | 239.84 ± 121.10Ψ* |

Ψ*Hill coefficient was not determined due to low affinity

The receptor binding assays showed that M40403 had no significant affinity for mu or delta receptors but showed approximately 240 nM suggesting moderate affinity at this receptor.

### EXAMPLE 4

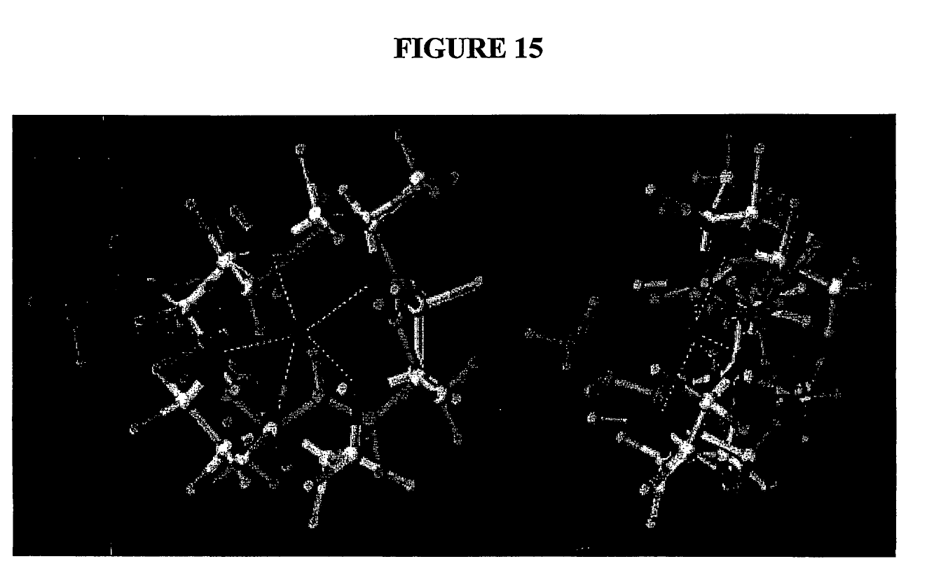

In order to determine the geometric feasibility of designing macroazacrowns (MACs) to mimic biologically active peptide conformations, the set of classic β-turns was used and compared with a small set of MAC crystal structures for overlap of the α-β side-chain vectors. 11 crystal structures of MACs with different substituent patterns and complexed with 3 different metals (Mn, Fe, Cd) were examined to compare the relative orientations of side chains with those seen in parent CPPs or other structures of interest such as β-turns. The CADD tool FOUNDATION was used to find overlap of the vectors corresponding to side-chain orientations between ideal β-turn conformations and the crystal structure of the MAC metal complexes (Reaka, Ho and Marshall, unpublished). Referring to FIG. 15, in a simple example, the Mn(II) complex shown orients the side-chain substituents almost exactly as those seen for the i, i+1, and i+2 residue of an ideal type I β-turn. As a peptidomimetic of this turn, it suffers from the fact that only three of the four side chains of the β-turn are oriented correctly. Nevertheless, if only those three side chains that correctly overlap are involved in receptor recognition, then the Mn-complex should show activity.

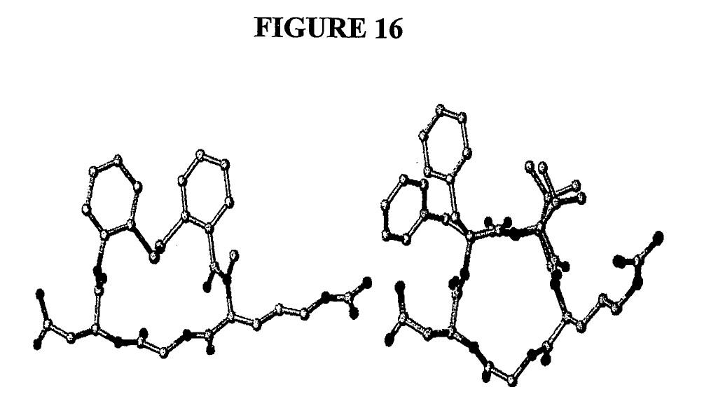

Referring now to FIG. 16, two cyclic pentapeptides with nanomolar affinities were used by Nikiforovich, et al. to determine the conformation of RGD when bound to integrin receptors. The best-known case employing NMR spectroscopy in elucidating CPP pharmacophores is the work on RGD-containing CPPs by the Kessler group. They have found that both c(RGDfV) and c(RGDFv) are almost equally potent inhibitors of binding α_{IIb}β₃ integrins to fibrinogen and αᵥβ₃ integrins to vitronectin (with affinities of a few hundred nanomolar).

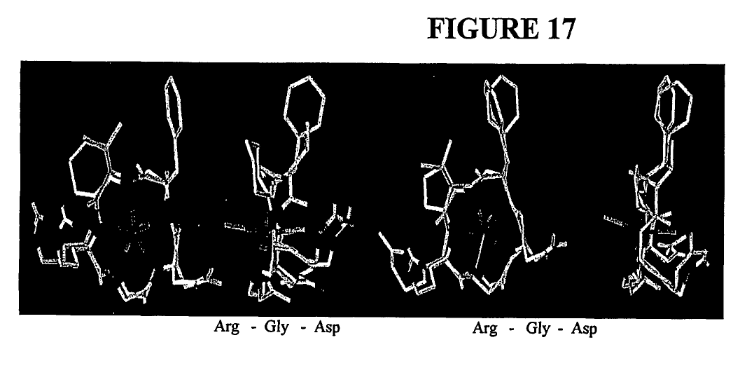

Overlap of these conformers is depicted in FIG. 17, which can be regarded as the three-dimensional pharmacophore model for RGD-containing CPPs devoid of any discrepancies, and in good agreement with the model for the RGD phamacophore proposed by other authors.

Using these backbones as templates, SYBYL, produced by Tripos, Inc. of St. Louis, Mo., was utilized to remove the backbone carbonyls. The structures tested all contained the RGD motif, as it is essential for recognition. The other two positions were varied with several amino acid side chains and carbocycles that included both the R and S configurations. Each ligand structure was minimized uncomplexed. Analysis of the ligands comprised of measuring all Φ and ψ angles that were compared to those of cyclo(RGDFv) and cyclo(RGDfV). Distances across the macrocycle, specifically between the α-carbons of the arginine and aspartic acid residues, were measured, as well as the dihedral angle of the Cα-Cβ of the Arg and Asp side chains. Once the best structures from Sybyl were determined (as compared to cyclo(RGDFv) and cyclo(RGDfV)) they were transferred to CaChe to be examined again with a metal complexed in the macrocycle. Three metals were tested (zinc, manganese and nickel) all with varying degrees of success in mimicking the RGD template. There were two structures found that matched the cyclo(RGDFv) and cyclo(RGDfV) templates. One was the pentaazacycle cyclored(RGDaA) (where cyclored indicates the pentaaza ring, i.e. no carbonyls on the backbone). The second had a fused cyclohexane ring cyclored(RGDach) where ch indicates the cyclohexane ring. Both have zinc as the complexing metal.

Relevant Measurements for the Various Cyclic Structures

| | Arg - Asp | Arg - Asp | | | | | | | | | | |
|---|---|---|---|---|---|---|---|---|---|---|---|---|
| | Dihedral | αC | | | | | | | | | | |
| | (αCβC- | distance | | | | | | | | | | |
| Structure | αCβC) | (Å) | Φ₁ | ψ₁ | Φ₂ | ψ₂ | Φ₃ | ψ₃ | Φ₄ | ψ₄ | Φ₅ | ψ₅ |
| Cyclo(RGDfV) | 19.8 | 6.09 | −84 | −75 | −76 | −76 | −104 | −57 | −60 | −81 | −111 | −52 |
| Cyclo(RGDFv) | 18.8 | 6.00 | −102 | −72 | −74 | −78 | −103 | −52 | −115 | 90 | 113 | −73 |
| Cyclored(RGDaA) | 21.8 | 5.90 | 153 | −49 | 178 | −29 | −160 | 54 | −156 | −14 | −93 | −53 |
| Cyclored(RGDach) | 21.0 | 5.66 | −174 | −41 | −176 | −51 | 173 | −8 | −173 | 48 | −177 | −32 |
| Cyclored(RGDacp) | 13.7 | 5.75 | 159 | −46 | −94 | −49 | −169 | −7 | −165 | 47 | −174 | −46 |

The best overlap structure examined was cyclored (RGDFcp) that incorporates a fused cyclopentane ring (FIG. 6) instead of a cyclohexane constraint. The increased ring strain of the cyclopentane greatly decreases the pucker of the macrocycle making a much better match against the peptide templates.

### EXAMPLE 5

Receptor binding studies are conducted on human opioid receptors transfected into Chinese hamster ovary (CHO) cells. The μ cell line is maintained in Ham's F-12 medium supplemented with 10% fetal bovine serum and 400 μg/ml GENETICIN (G418 sulfate). The δ cell line is maintained in Ham's F-12 medium supplemented with 10% fetal bovine serum and 500 μg/ml hygromycin B. The k cell line is maintained in Dulbecco's minimal essential medium (DMEM) supplemental with 10% fetal bovine serum, 400 μg/ml GENETICIN (G418 sulfate) and 0.1% penicillin/streptomycin. All cell lines are grown to full confluency, then harvested for membrane preparation. The membrane used for functional assays is prepared in buffer A (20 mM HEPES, 10 mM MgCl₂, and 100 mM NaCl at pH 7.4) and the membrane for binding assays is prepared in 50 mM Tris buffer, pH 7.7. Cells are harvested by scraping the plates with a rubber policeman and then centrifuged at 500×g for 10 minutes. The cell pellet is suspended in buffer A or Tris buffer, homogenized in a Polytron Homogenizer, and centrifuged at 20,000×g for 20 minutes. The cell pellet is washed in buffer A or Tris, centrifuged at 20,000×g for another 20 minutes and finally suspended in a small amount of buffer to determine protein content. Membrane is aliquoted in small vials at a concentration of 6 mg/ml per vial and stored at −70° C. and used as needed.

Routine binding assays are conducted using [³H]DAMGO, [³H]Cl-DPDPE, and [³H]U69,593 to bind to μ, δ and k receptors, respectively. For μ and δ binding, cell membranes are incubated with the appropriate radioligand and unlabeled drug in a total volume of 200 μl in 96-well plates, usually for 1 hour at 25° C. For k binding cell membranes are incubated in a total volume of 2 ml in tubes rather than plates, as the number of opiate receptors or receptor occupancy in k cell line has not been as high as in other cell lines. For routine experiments, membranes are incubated with the test compounds at concentrations ranging from 10⁻⁵ to 10⁻¹⁰ M. After the incubation, samples are filtered through glass fiber filters by using a Tomtec cell harvester. Filters are dried overnight before radioactivity levels are determined. Nonspecific binding is determined by using 1.0 μM of the unlabeled counterpart of each radioligand.

Full characterization of compounds includes analysis of the data for IC₅₀ values and Hill coefficients by using the program PRIMS. Kᵢ values are calculated using the Cheng Prusoff transformation:

$${K}_{i} = \frac{I {C}_{50}}{1 + L / {K}_{d}}$$

where L is radioligand concentration and K_{d} is the binding affinity of the radioligand, as determined previously by saturation analysis.

### EXAMPLE 6

Membrane prepared as described above are incubated with [³⁵S]GTPyS (50 pM); GDP (usually 10 μM), and the desired compound, in a total volume of 200 μl, for 60 minutes at 25° C. Samples are filtered over glass fiber filters and counted as described for the binding assays. A dose response curve with a prototypical full agonist (DAMGO, DPDPE, and U69593, for μ, δ, and k receptors, respectively) is conducted in each experiment to identify full and partial agonist compounds.

High affinity compounds (Kᵢ value is 200 nM or less) that demonstrate no agonist activity are tested as antagonists. For each compound a full Schild analysis is conducted, utilizing a full agonist dose response curve in the presence of at least three concentrations of the antagonist. pA₂ values and Schild slopes are determined using a statistical program designed for these experiments. If the Schild slope is significantly different from −1.00, the antagonism cannot be called competitive, and thus no pA₂ value can be reported. For these compounds only the equilibrium dissociation constant (Kₑ) will be listed on the summary page. The equilibrium dissociation constant (Kₑ) is calculated from the following equation:

Kₑ=a/Dr−1

where “a” is the nanomolar concentration of antagonist and DR is the virtual shift of the agonist concentration-response curve to the right in the presence of a given concentration of antagonist.

Male Hartley guinea pigs of 350-400 g are decapitated, and the small intestine is removed; about 20 cm of the terminal ileum is discarded. The longitudinal muscle with the myenteric plexus attached is gently separated from the underlying circular muscle by the method of Paton and Vizi (1969). The muscle strip is mounted in an 8-ml, water-jacketed organ bath containing Krebs-bicarbonate solution of the following composition (in mM): NaCl 118, CaCl₂ 2.5, KCl 4.7, NaHCO₃ 25, KH₂PO₃ 1.2, MgSO₄ 1.2, and glucose 11.5. The tissues are kept at 37° C. and bubbled with 5% of CO₂ in oxygen. An initial tension of 0.6 g is applied to the strips. The muscle strip is stimulated for 60 minutes before the start of each experiment. Field electrical stimulation is delivered through platinum wire electrodes positioned at the top and bottom of the organ bath and kept at a fixed distance apart (3.5 cm). The upper electrode is a ring that is 4 mm in diameter. The parameters of rectangular stimulation are supramaximal voltage, 1-ms impulse duration at 0.1 Hz. A Grass S-88 electrostimulator is used for stimulation. The electrically induced twitches are recorded using an isometric transducer (Metrigram) coupled to a multichannel polygraph (Gould 3400).

The agonist potencies of test compounds is determined from concentration-response curves and characterized by their IC₅₀ values. IC₅₀ is defined as the concentration of the agonist that causes 50% inhibition of the electrically induced contractions.

Compounds with antagonist activity are characterized by the equilibrium dissociation (Kₑ) calculated from the following equation:

Kₑ=a/Dr−1

where “a” is the nanomolar concentration of antagonist and DR is the virtual shift of the agonist concentration-response curve to the right in the presence of a given concentration of antagonist.

TABLE 6
Results

| | |
|---|---|
| MU Binding | Delta Binding |
| Date: Jul. 2, 1999 | Date: Jul. 2, 1999 |
| Drug: 20,636 | Drug: 20,636 |
| Hot Ligand: [³H]DAMGO | Hot Ligand: [³H]DPDPE-CL |
| Avg. Total Hot: 80956 CPM | Avg. Total Hot: 61973 CPM |
| IC₅₀ > 10,000 nM | IC₅₀ > 10,000 nM |
| MU Binding | Delta Binding |
| Date: Jul. 5, 1999 | Date: Jul. 5, 1999 |
| Avg. Total Hot: 80326 CPM | Avg. Total Hot: 63117 CPM |
| Confirmation of IC₅₀ > 10,000 nM | Confirmation of IC₅₀ > 10,000 nM |

In view of the above, it will be seen that several objectives of the invention are achieved and other advantageous results attained. Having described the invention in detail, those skilled in the art will appreciate that other embodiments may be made of the invention without departing from the spirit of the invention described herein. Therefore, it is not intended that the scope of the invention be limited to the specific and preferred embodiments illustrated and described herein. Rather, it is intended that the scope of the invention be determined by the appended claims and their equivalents.

What is claimed is:

1. A method of conformationally constraining a flexible molecule for use in determination of the three-dimensional conformation and location of one or more active sites on said molecule for binding with a receptor of interest comprising the steps of:
(a) providing a molecule selected from the group consisting of peptides and peptidomimetics having a metal ion complexing backbone with at least one amide moiety therein;
(b) substituting at least one hydroxamate or hydroxamate analog moiety for at least one amide moiety in said backbone to provide at least one metal ion binding site on said backbone; and
(c) complexing a metal ion to said molecule at said metal ion binding site thereby constraining the conformation of said molecule.

2. The method of claim 1 wherein said molecule is a cyclic peptide.

3. The method of claim 1, further comprising the step of selecting at least one desired section of said backbone to act as a metal ion binding site candidate to form a desired conformation of said molecule.

4. The method of claim 3 wherein the conformation of active sites of said molecule is confirmed by nuclear magnetic resonance.

5. The method of claim 3 wherein the conformation of active sites of said molecule is confirmed by crystallography.

6. The method of claim 1 wherein said metal ion is the ionic form of an element selected from the group consisting of iron, copper, manganese, nickel, zinc, arsenic, selenium, technetium, gadolinium, cobalt, ruthenium, palladium, silver, cadmium, indium, antimony, rhenium, osmium, iridium, platinum, gold, mercury, thallium, lead, bismuth, polonium, astatine, actinium, thorium, protactinium, uranium, neptunium, plutonium, americium, curium, berkelium, californium, einsteinium, fermium, mendelevium, nobelium, lawrencium, cerium, praseodymium, neodymium, promethium, samarium, europium, gadolinium, terbium, dysprosium, holmium, erbium, thulium, ytterbium, and lutetium.

7. The method of claim 1 wherein said metal ion is a medically useful metal ion.

8. The method of claim 1 wherein said metal ion is radioactive or paramagnetic.

9. A method for establishing a three-dimensional conformation and location of one or more active sites on a flexible molecule for binding with a receptor of interest comprising the steps of:
(a) providing a molecule selected from the group consisting of peptides and peptidomimetics having a metal ion complexing backbone with at least one amide moiety therein;
(b) selecting at least one desired section of said backbone to act as a metal ion binding site candidate to form a desired conformation of said molecule;
(c) substituting at least one hydroxamate or hydroxamate analog moiety for at least one amide moiety at said metal ion binding site candidate of said desired section of said backbone;
(d) complexing a metal ion to said molecule at said metal ion binding site candidate thereby constraining the conformation of said molecule;
(e) testing said molecule to determine the binding affinity of said molecule to said receptor of interest;
(f) analyzing the three-dimensional structure and location of one or more active sites on said molecule to determine the receptor-bound conformation of said molecule.

10. The method of claim 9 wherein said molecule is a cyclic peptide.

11. The method of claim 9 wherein the conformation of active sites of said molecule is confirmed by nuclear magnetic resonance.

12. The method of claim 9 wherein the conformation of active sites of said molecule is confirmed by crystallography.

13. The method of claim 9 wherein said metal ion is the ionic form of an element selected from the group consisting of iron, copper, manganese, nickel, zinc, arsenic, selenium, technetium, gadolinium, cobalt, ruthenium, palladium, silver, cadmium, indium, antimony, rhenium, osmium, iridium, platinum, gold, mercury, thallium, lead, bismuth, polonium, astatine, actinium, thorium, protactinium, uranium, neptunium, plutonium, americium, curium, berkelium, californium, einsteinium, fermium, mendelevium, nobelium, lawrencium, cerium, praseodymium, neodymium, promethium, samarium, europium, gadolinium, terbium, dysprosium, holmium, erbium, thulium, ytterbium, and lutetium.

14. The method of claim 9 wherein said metal ion is a medically useful metal ion.

15. The method of claim 9 wherein said metal ion is radioactive or paramagnetic.

16. The method of claim 9 wherein said testing step is performed using a high-throughput assay.

17. A method of conformationally constraining a flexible molecule for use in determination of the three-dimensional conformation and location of one or more active sites on said molecule for binding with a receptor of interest comprising the steps of:
(a) providing a molecule selected from the group consisting of peptides and peptidomimetics having the general formula: 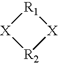
wherein R1 and R2 each comprise from about one to twenty amino acids;
wherein R1 and R2 are linked by X;
wherein X is a metal ion complexing backbone comprising at least one hydroxamate or hydroxamate analog moiety therein;
wherein said at least one hydroxamate moiety acts as a metal ion binding site; and
(b) complexing a metal ion to said molecule at said metal ion binding site thereby constraining the conformation of said molecule.

18. The method of claim 17 wherein X comprises at least three hydroxamate or hydroxamate analog moieties.

19. The method of claim 17 wherein X comprises at least four hydroxamate or hydroxamate analog moieties.

20. The method of claim 17 wherein X comprises at least five hydroxamate or hydroxamate analog moieties.

21. A method of establishing a three-dimensional conformation and location of one or more active sites on a flexible molecule for binding with a receptor of interest comprising the steps of:
(a) providing at least one cyclic peptide molecule;
(b) reducing sufficient amide bonds to secondary amines in said cyclic peptide molecule to generate at least one chiral azacrown;
(c) complexing a metal ion to said chiral azacrown thereby constraining the conformation of said chiral azacrown;
(d) testing said chiral azacrown molecule to determine the binding affinity of said chiral azacrown to said receptor of interest; and
(e) analyzing the three-dimensional structure and location of one or more active sites on said chiral azacrown to determine the receptor-bound conformation of said chiral azacrown.

22. The method of claim 21 wherein said cyclic peptide molecule is a cyclopentapeptide.

23. The method of claim 21 wherein said cyclic peptide molecule is a cyclotetrapeptide.

24. The method of claim 21 wherein said cyclic peptide molecule is a cyclohexapeptide.

25. The method of claim 21 wherein said chiral azacrown is a chiral pentaazacrown.

26. The method of claim 21 wherein said metal ion is the ionic form of an element selected from the group consisting of iron, copper, manganese, nickel, zinc, arsenic, selenium, technetium, gadolinium, cobalt, ruthenium, palladium, silver, cadmium, indium, antimony, rhenium, osmium, iridium, platinum, gold, mercury, thallium, lead, bismuth, polonium, astatine, actinium, thorium, protactinium, uranium, neptunium, plutonium, americium, curium, berkelium, californium, einsteinium, fermium, mendelevium, nobelium, lawrencium, cerium, praseodymium, neodymium, promethium, samarium, europium, gadolinium, terbium, dysprosium, holmium, erbium, thulium, ytterbium, and lutetium.

27. The method of claim 21 wherein said metal ion is a medically useful metal ion.

28. The method of claim 21 wherein said metal ion is radioactive or paramagnetic.

29. A method of designing molecules having a desired biological activity comprising:
(a) isolating a biologically active molecule of interest;
(b) analyzing the conformation of said biologically active molecule;
(c) developing at least one hypothesis for the correct three-dimensional conformation and location of one or more active sites on said molecule for binding to a receptor of interest;
(d) generating at least one active constrained analog of said biologically active molecule to conform to said hypothesis;
(e) testing said analog to determine the binding affinity of said analog to said receptor of interest;
(f) mapping the three-dimensional conformation and location of one or more active sites on said analog in a receptor-bound conformation; and
(g) designing at least one molecule which mimics said three-dimensional conformation and location of one or more active sites on said analog.

30. The method of claim 29 wherein step (d) further comprises the steps of providing a molecule selected from the group consisting of peptides and peptidomimetics having a metal ion complexing backbone with at least one amide moiety therein; selecting at least one desired section of said backbone to act as a metal ion binding site in accordance with said hypothesis of the placement of said active sites; substituting at least one hydroxamate or hydroxamate analog moiety for said at least one amide moiety in said backbone at said desired section to provide at least one metal ion binding site on said backbone; and complexing a metal ion to said molecule at said at least one metal ion binding site thereby generating an active constrained analog of said molecule in accordance with said hypothesis.

31. The method of claim 29 wherein step (d) further comprises the steps of:
(d)(1) providing a molecule selected from the group consisting of peptides and peptidomimetics having the general formula: 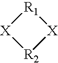
wherein R1 and R2 each comprise from about 1 to 20 amino acids;
wherein R1 and R2 are linked by X;
wherein X is a complexing backbone for complexing a metal ion comprising at least one hydroxamate or hydroxamate analog;
wherein said at least one hydroxamate moiety acts as a metal ion binding site; and
(d)(2) complexing a metal ion to said molecule at said backbone thereby generating an active constrained analog of said molecule in accordance with said hypothesis.

32. The method of claim 29 wherein step (d) further comprises the steps of:
(d)(1) providing at least one cyclic peptide molecule; (d)(2) reducing sufficient amide bonds to secondary amines in said cyclic peptide molecule to generate at least one chiral azacrown; and (d)(3) complexing a metal ion to said chiral azacrown.

33. A library of conformationally constrained molecules selected from the group consisting of peptides and peptidomimetics which are candidates targeted for one or more desired properties comprising an array of at least five different molecules having different chiralities and combinations thereof wherein any of said candidate molecules are retrievable and analyzable for said one or more desired target properties.

34. The library of claim 33 wherein said array comprises at least ten different molecules.

35. The library of claim 33 wherein at least a portion of said molecules in said library are conformationally constrained through metal ion complexation.

36. The library of claim 33 wherein said peptidomimetics comprises chiral comprises.

37. A method of selecting a naturally-occurring molecule having a desired biological activity comprising the steps of:
(a) obtaining a library of conformationally constrained molecules selected from the group consisting of peptides and peptidomimetics comprising an array of at least five different molecules having different chiralities and combinations thereof;
(b) screening said library for at least one molecule having a desired binding affinity to a receptor of interest using a biological assay;
(c) deriving a three-dimensional structure and location of one or more active sites of said at least one molecule in its receptor-bound conformation;
(d) selecting at least one naturally-occurring molecule having a substantially similar conformation to said at least one molecule; and
(e) testing said at least one naturally-occurring molecule for said desired biological activity.

38. A method of obtaining a pharmacophore which mimics a desired biological-function domain comprising the steps of:
(a) obtaining a library of conformationally constrained molecules selected from the group consisting of peptides and peptidomimetics comprising an array of at least five different molecules having different chiralities and combinations thereof;
(b) screening said library for at least one molecule having a binding affinity to a receptor of interest;
(c) selecting a molecule having a desired biological-function domain;
(d) analyzing the three-dimensional structure and location of one or more active sites of said molecule; and
(e) producing a pharmacophore which mimics the three-dimensional structure and location of one or more said active sites of said molecule.

39. A library of conformationally constrained biologically active molecules for elucidation of a three-dimensional structure and location of one or more binding sites of said molecules comprising:
an array of at least five flexible molecules selected from the group consisting of peptides and peptidomimetics having different chiralities and combinations thereof;
wherein each of said molecules has less than five well-defined three-dimensional structures when bound to a receptor of interest;
wherein each of said molecules is synthetically available; and
wherein at least one side chain of each of said molecules can be uniquely oriented during interaction with said receptor.
